(19) United States
(12) Patent Application Publication
(10) Pub. No.: US 2026/0296277 A1
(43) Pub. Date: Oct. 1, 2026

(54) CHILD SAFETY SEAT

(71) Applicant: Wonderland Switzerland AG, Steinhausen (CH)

(72) Inventors: Manqun CHENG, Dongguan (CN); Guozhu ZENG, Dongguan (CN); Xiaolong MO, Dongguan (CN)

(73) Assignee: Wonderland Switzerland AG, Steinhausen (CH)

(21) Appl. No.: 19/490,226

(22) PCT Filed: Jun. 5, 2024
(86) PCT No.: PCT/EP2024/065455

§ 371 Date: Dec. 4, 2025

(30) Foreign Application Priority Data
Jun. 5, 2023 (CN) 202310659857.3
Aug. 4, 2023 (CN) 202310981777.X
May 29, 2024 (CN) 202410683405.3

(51) Int. Cl. B60N 2/56; B60N 2/28

(52) U.S. Cl. CPC B60N 2/5642; B60N 2/2818; B60N 2/2881

(57) ABSTRACT

A child safety seat includes: a seat; a seat cushion arranged on the seat; a heating apparatus detachably arranged in the seat cushion; a control apparatus arranged in the seat, the heating apparatus being electrically connected to the control apparatus; a first temperature measuring apparatus arranged on the seat cushion and communicably connected to the control apparatus, the first temperature measuring apparatus being configured to measure a real-time temperature of the heating apparatus; and a thermal safety apparatus arranged on the heating apparatus and configured to cause the heating apparatus to stop heating when the heating apparatus reaches a first preset temperature. The heating apparatus includes: a heating member; and a flame-retardant member, the heating member being arranged in the flame-retardant member. The first temperature measuring apparatus is arranged on the flame-retardant member, and the thermal safety apparatus is arranged at the heating member.

### CROSS-REFERENCE TO RELATED APPLICATIONS

This application is a U. S National Phase Application under 35 U.S. C § 371 based upon International Patent Application No. PCT/EP2024/065455, filed on Jun. 5, 2024, which itself claims priority to Chinese Patent Application No. 202310659857.3, filed on Jun. 5, 2023, Chinese Patent Application No. 202310981777.X, filed on Aug. 4, 2023, and Chinese Patent Application No. 202410683405.3, filed on May 29, 2024. The contents of the above identified applications are hereby incorporated herein in their entireties by reference.

### TECHNICAL FIELD

The present disclosure relates to the field of children product technologies, and in particular to a child safety seat.

### BACKGROUND

Child safety seats are widely used to ensure safety of child passengers in vehicles. When temperatures inside the vehicles are low, such as in winter, temperatures of the child safety seats may also be relatively low, resulting in poor sitting comfort of the child safety seats. In extreme cases, children sitting thereon may even catch a cold. When the temperatures inside the vehicles are high, such as in summer, the temperatures of the child safety seats may also be relatively high, resulting in poor sitting comfort of the child safety seats. Further, due to safety design of the child safety seats, the child safety seats are more enveloping for the children sitting thereon, which affects heat dissipation to some extent and aggravates a decrease in comfort caused by higher temperatures.

### SUMMARY

Based on this, there is a need to provide a child safety seat, which, on the one hand, can heat the child safety seat at lower temperatures and, on the other hand, can also ventilate the child safety seat to dissipate heat at higher temperatures.

According to an aspect of the present disclosure, a child safety seat is provided, and the child safety seat includes: a seat, a seat cushion, a heating apparatus, and a control apparatus. The seat is arranged on the seat. The heating apparatus is detachably arranged in the seat cushion. The control apparatus is arranged in the seat. The heating apparatus is electrically connected to the control apparatus.

The child safety seat according to the embodiments of the present disclosure realizes controllable heating of the seat through the heating apparatus and the control apparatus, improving sitting comfort of the child safety seat.

In an embodiment, the child safety seat further includes: a first temperature measuring apparatus and a thermal safety apparatus. The first temperature measuring apparatus is arranged on the seat cushion and communicably connected to the control apparatus, and the first temperature measuring apparatus is configured to measure a real-time temperature of the heating apparatus. The thermal safety apparatus is arranged on the heating apparatus and configured to cause the heating apparatus to stop heating when the heating apparatus reaches a first preset temperature.

In an embodiment, the first temperature measuring apparatus is a temperature detection chip; and the thermal safety apparatus is a resettable thermal fuse.

In an embodiment, the heating apparatus includes: a heating member and a flame-retardant member. The heating member is arranged in the flame-retardant member. The first temperature measuring apparatus is arranged on the flame-retardant member, and the thermal safety apparatus is arranged at the heating member.

In an embodiment, the heating apparatus further includes: a heat dissipation hole arranged in the flame-retardant member. An accommodation space is formed in the seat cushion, the heating apparatus is detachably arranged in the accommodation space of the seat cushion, and the accommodation space is provided with an openable and closable opening.

In an embodiment, an edge of the heating apparatus is provided with a positioning concave portion, an edge of the accommodation space is provided with a positioning convex portion, and the heating apparatus is fixed in the accommodation space through shape fit of the positioning concave portion and the positioning convex portion.

In an embodiment, the heating apparatus further includes: a connection terminal, and the heating member is detachably and electrically connected to the control apparatus through the connection terminal. The thermal safety apparatus is connected in series with the heating member.

In an embodiment, the heating member includes a heating wire made of metal and/or carbon fiber, or a heating mesh made of graphene.

In an embodiment, the control apparatus further includes: a control unit arranged in the seat, and the heating apparatus is electrically connected to the control unit. The first temperature measuring apparatus is communicably connected to the control unit, and the control unit is configured such that the control unit controls the heating member to stop heating when a temperature measured by the first temperature measuring apparatus reaches a second preset temperature; and/or the control unit controls the heating member to start heating or allows the heating member to continue heating when the temperature measured by the first temperature measuring apparatus is lower than the second preset temperature. The second preset temperature is user-adjustable, and a maximum value of the second preset temperature is less than the first preset temperature.

In an embodiment, the control apparatus further includes: an operating unit and a wireless communication module. The operating unit is arranged on the child safety seat and communicably connected to the control unit. The operating unit is configured to adjust an operating state of the heating apparatus. The control unit is wirelessly and communicably connected to an external device through the wireless communication module, and the external device is configured to adjust the operating state of the heating apparatus.

In an embodiment, the child safety seat further includes: a ventilation apparatus, an upper cover, and an accommodation cavity. The ventilation apparatus is arranged in the seat and electrically connected to the control apparatus. The upper cover is provided with a first vent, and the upper cover covers the accommodation cavity. The ventilation apparatus is arranged in the accommodation cavity, and the seat cushion is arranged on the upper cover.

The child safety seat according to the embodiments of the present disclosure realizes ventilation and heat dissipation of the seat through the ventilation apparatus, improving sitting comfort of the child safety seat.

In an embodiment, the ventilation apparatus includes: a first fixed base and a fan. The first fixed base is fixedly arranged in the accommodation cavity, and an air duct is formed between the first fixed base and the upper cover. The fan is fixedly arranged on the first fixed base and electrically connected to the control apparatus. The first fixed base is provided with an air inlet and an air outlet, the air inlet is in fluid communication with a third vent at a backrest of the seat, and the air outlet is in fluid communication with the air duct.

In an embodiment, the air duct is recessed in a direction away from the seat cushion.

In an embodiment, a height of the air duct in an air circulation direction is less than a height of the air outlet, and a cross-sectional area of the air duct in the air circulation direction is larger than a cross-sectional area of the air outlet.

In an embodiment, the ventilation apparatus further includes: a second temperature measuring apparatus and a control unit. The second temperature measuring apparatus is arranged on the upper cover and communicably connected to the control apparatus, and the second temperature measuring apparatus is configured to measure a real-time temperature of the seat. The control unit is arranged in the accommodation cavity, and the fan is electrically connected to the control unit. The second temperature measuring apparatus is communicably connected to the control unit, and the control unit is configured such that the control unit controls the fan to stop ventilation when a temperature measured by the second temperature measuring apparatus is lower than a third preset temperature; and/or the control unit controls the fan to start ventilation or allows the fan to continue ventilation when the temperature measured by the second temperature measuring apparatus reaches the third preset temperature.

In an embodiment, the first fixed base further includes: a first guide rib arranged at an end of the first fixed base close to the air outlet, the guide rib defining a first guide space between the air outlet and the air duct, the first guide space being configured such that a cross-sectional area of the first guide space gradually becomes larger along a direction from the air outlet to the air duct.

In an embodiment, the first fixed base further includes: a second guide rib arranged at an end of the first fixed base away from the air outlet, the second guide rib defining a second guide space in the air duct, the second guide space being configured such that a cross-sectional area of the second guide space gradually decreases along the direction from the air outlet to the air duct.

In an embodiment, the first guide space is configured such that a width thereof gradually becomes larger along the direction from the air outlet to the air duct; and the second guide rib has a U-shaped structure, and the second guide rib is arranged at a position opposite to the air outlet.

In an embodiment, the ventilation apparatus further includes: a second fixed base arranged in the accommodation cavity, the second fixed base being fixedly connected to a side of the first fixed base facing away from the upper cover, and a safety belt guide groove is defined between the second fixed base and the first fixed base.

In an embodiment, the ventilation apparatus further includes: a lower cover arranged in the accommodation cavity, the lower cover being connected to a side of the second fixed base facing away from the first fixed base, a mounting space is defined between the lower cover and the second fixed base, and the control unit is fixedly arranged in the mounting space. The control apparatus further includes: an operating unit arranged on the seat and communicably connected to the control unit, the operating unit being configured to adjust an operating state of the ventilation apparatus.

According to an aspect of the present disclosure, a child safety seat is provided, and the child safety seat includes: a seat including an upper cover; a plurality of fans; and a plurality of air guide members having a hollow air duct and a plurality of second vents, the second vents being arranged on a side facing the upper cover and in fluid communication with the air duct. The plurality of air guide members are in fluid communication with the plurality of fans respectively.

In an embodiment, the plurality of air guide members are spaced apart on two lateral sides of the upper cover respectively, and a recess is formed by the plurality of air guide members and the upper cover.

In an embodiment, the child safety seat further includes a fixed plate, the fixed plate being fixedly connected to at least two air guide members of the plurality of air guide members, and the fixed plate forming a channel with the recess.

In an embodiment, the upper cover is provided with a through hole configured to allow a safety belt length adjustment end to pass through, the through hole being in communication with the recess or the channel.

In an embodiment, the fixed plate is arranged to extend from the back of the seat to a seat portion of the seat, and the fixed plate includes: a back section arranged on the back of the seat; a seat section arranged on the seat portion of the seat; and a connecting section connected between the back section and the seat section.

In an embodiment, the air guide member is provided as an elongated structure and extends from the back of the seat to the seat portion of the seat.

In an embodiment, the air guide member is provided with a carrying rib, the upper cover is provided with a first rib extending along a vertical direction, and a carrying hole is arranged in a side wall of the first rib, the carrying rib being inserted into the carrying hole to fix the air guide member to the upper cover.

In an embodiment, the upper cover is further provided with a second rib extending along a horizontal direction, and the first rib and the second rib form a reinforcing groove in the upper cover, the reinforcing groove being provided with a ventilation opening.

In an embodiment, an end of the carrying rib passing through the carrying hole is provided with an air opening, the air opening being in fluid communication with the air duct and being in fluid communication with the upper cover through the ventilation opening.

In an embodiment, the upper cover is provided with a plurality of first vents located above the air guide members and pores located above the recess between the air guide members. The first vent and the second vent are arranged to overlap.

In an embodiment, the air guide member includes: an air duct upper cover arranged on a side of the air guide member close to the upper cover, the second vent being arranged in the air duct upper cover; and an air duct lower cover arranged on a side of the air guide member facing away from the upper cover, the air duct lower cover and the air duct upper cover being fastened to each other to form an air duct. The fan is fixedly connected to the air duct upper cover, and the air duct upper cover is fixedly connected to the upper cover.

In an embodiment, the air duct upper cover is provided with a fan mounting portion, a shape of the fan mounting portion matches a shape of the fan, and the fan is fixedly connected to the fan mounting portion. The fan mounting portion forms part of a housing of the fan.

In an embodiment, the plurality of air guide members include two air guide members, the two air guide members extending along a longitudinal direction of the upper cover so that the second vents are distributed over a wing adjacent to the seat; air ducts of the two air guide members are independent of each other; each of the two air guide members is connected to one fan; and the fan is connected to a first end of the air guide member, and the carrying rib is located at a second end of the air guide member.

In an embodiment, a side edge of an air duct upper cover includes a first engaging member, a side edge of an air duct lower cover includes a second engaging member, and when the air duct lower cover and the air duct upper cover are fastened to each other, the first engaging member is engaged with the second engaging member to fixedly connect the air duct lower cover to the air duct upper cover.

In an embodiment, a side edge of the fixed plate is provided with an extension portion, the extension portion covering and supporting the air duct lower cover.

In an embodiment, the child safety seat further includes a control apparatus, including: a control unit arranged on the fixed plate, the fan being electrically connected to the control unit; an operating unit arranged on the seat and communicably connected to the control unit, the operating unit being configured to adjust an operating state of the fan; and a wireless communication module, the control unit being wirelessly and communicably connected to an external device through the wireless communication module, the external device being configured to adjust the operating state of the fan.

In an embodiment, a side of the fixed plate facing away from the upper cover is provided with a receiving box and a cover body, and the control unit is fixedly arranged in the receiving box, the cover body being detachably fixed to the receiving box to close the receiving box.

According to an aspect of the present disclosure, a child safety seat is provided, and the child safety seat includes: a seat; a seat cushion arranged on the seat; a heating apparatus detachably arranged in the seat cushion; a control apparatus arranged in the seat, the heating apparatus being electrically connected to the control apparatus; a first temperature measuring apparatus communicably connected to the control apparatus, the first temperature measuring apparatus being configured to measure a real-time temperature of the heating apparatus; and a thermal safety apparatus arranged on the heating apparatus and configured to cause the heating apparatus to stop heating when the heating apparatus reaches a first preset temperature. The heating apparatus includes: a heating member; and a flame-retardant member, the heating member being arranged in the flame-retardant member. The first temperature measuring apparatus is arranged on the flame-retardant member or on the seat cushion, the thermal safety apparatus is connected in series with the heating member, and the first temperature measuring apparatus is a temperature detection chip; and the thermal safety apparatus is a resettable thermal fuse.

In an embodiment, the heating apparatus further includes: a heat dissipation hole arranged in the flame-retardant member. A bag-like accommodation space is formed in the seat cushion, the heating apparatus is detachably arranged in the accommodation space of the seat cushion, the accommodation space is provided with an openable and closable opening, an edge of the heating apparatus is provided with a positioning concave portion, an edge of the accommodation space is provided with a positioning convex portion, and the heating apparatus is fixed in the accommodation space through shape fit of the positioning concave portion and the positioning convex portion, and the thermal safety apparatus is arranged at the heating member.

In an embodiment, the control apparatus includes: a control unit arranged in the seat, and the heating apparatus is electrically connected to the control unit. The first temperature measuring apparatus is communicably connected to the control unit, and the control unit is configured such that the control unit controls the heating member to stop heating when a temperature measured by the first temperature measuring apparatus reaches a second preset temperature; and/or the control unit controls the heating member to start heating or allows the heating member to continue heating when the temperature measured by the first temperature measuring apparatus is lower than the second preset temperature. The first preset temperature is not user-adjustable, the second preset temperature is user-adjustable, and a maximum value of the second preset temperature is less than the first preset temperature.

In an embodiment, the child safety seat further includes: a ventilation apparatus arranged in the seat and electrically connected to the control apparatus; an upper cover provided with a first vent; and an accommodation cavity, the upper cover covering the accommodation cavity. The ventilation apparatus is arranged in the accommodation cavity, the seat cushion is arranged on the upper cover, and the ventilation apparatus includes: a first fixed base fixedly arranged in the accommodation cavity, an air duct being formed between the first fixed base and the upper cover; and a fan fixedly arranged on the first fixed base and electrically connected to the control apparatus. The first fixed base is provided with an air inlet and an air outlet, the air inlet is in fluid communication with a third vent at a backrest of the seat, and the air outlet is in fluid communication with the air duct. A height of the air duct in an air circulation direction is less than a height of the air outlet, and a cross-sectional area of the air duct in the air circulation direction is larger than a cross-sectional area of the air outlet.

In an embodiment, the first fixed base further includes: a guide rib arranged at an end of the first fixed base away from the air outlet, the guide rib defining a guide space in the air duct, the guide space being configured such that a cross-sectional area of the guide space gradually decreases along the direction from the air outlet to the air duct, the guide rib having a U-shaped structure, and the guide rib being arranged at a position opposite to the air outlet.

In an embodiment, the ventilation apparatus further includes: a second fixed base arranged in the accommodation cavity, the second fixed base being fixedly connected to a side of the first fixed base facing away from the upper cover, and a safety belt guide groove is defined between the second fixed base and the first fixed base.

According to an aspect of the present disclosure, a child safety seat is provided, and the child safety seat includes: a seat including an upper cover; a plurality of fans; and a plurality of air guide members having a hollow air duct and a plurality of vents, the vents being arranged on a side facing the upper cover and in fluid communication with the air duct. The plurality of air guide members are in fluid communication with the plurality of fans respectively, the plurality of air guide members are spaced apart on two lateral sides of the upper cover respectively, and a recess is formed by the plurality of air guide members and the upper cover.

In an embodiment, the child safety seat further includes a fixed plate, the fixed plate being fixedly connected to at least two air guide members of the plurality of air guide members, and the fixed plate forming a channel with the recess. The upper cover is provided with a through hole configured to allow a safety belt length adjustment end to pass through, the through hole being in communication with the recess or the channel.

In an embodiment, the air guide member is provided with a carrying rib, the upper cover is provided with a first rib extending along a vertical direction, and a carrying hole is arranged in a side wall of the first rib, the carrying rib being inserted into the carrying hole to fix the air guide member to the upper cover.

In an embodiment, the upper cover is further provided with a second rib extending along a horizontal direction, and the first rib and the second rib form a reinforcing groove in the upper cover, the reinforcing groove being provided with a ventilation opening. An end of the carrying rib passing through the carrying hole is provided with an air opening, the air opening being in fluid communication with the air duct and being in fluid communication with the upper cover through the ventilation opening.

In an embodiment, the air guide member further includes an air outlet port in fluid communication with the air duct, the air outlet port being closer to the fan than the vent. The child safety seat further includes: a support cushion assembly, the support cushion assembly being detachably mounted on the seat, a cavity being formed inside the support cushion assembly, an air hole in fluid communication with the cavity being formed on a bottom surface of the support cushion assembly, and the air hole being configured such that the air hole is in fluid communication with the air outlet port when the support cushion assembly is mounted on the seat; and a connecting member arranged on either of the seat and the support cushion assembly and capable of being inserted into the air outlet port to block fluid communication between the fan and the vent.

According to an aspect of the present disclosure, a child safety seat is provided, and the child safety seat includes: a seat. The seat includes: an upper cover provided with a ventilation hole; a fan; an air guide member arranged below the upper cover and in fluid communication with the fan, the air guide member having a hollow air duct and an air outlet port, the air outlet port being arranged on a side of the air guide member facing the upper cover and in fluid communication with the air duct; and a support cushion assembly detachably mounted on the seat, a cavity being formed inside the support cushion assembly, and an air hole in fluid communication with the cavity being formed on a bottom surface of the support cushion assembly. The air hole is configured such that the air hole is in fluid communication with the air outlet port when the support cushion assembly is mounted on the seat.

In an embodiment, the support cushion assembly is provided with a connecting member, and the air hole is formed in the connecting member, the connecting member being at least partially inserted into the air outlet port to enter the air duct. The connecting member includes a windward portion in fluid communication with the air hole and a windshielding portion that blocks fluid communication between the fan and the ventilation hole.

In an embodiment, the child safety seat further includes: a shielding sheet pivotably arranged on an upper surface of the upper cover or seat cloth, one side of the shielding sheet being provided with a hole-blocking member. The shielding sheet is pivotable between an open position and a closed position, at the closed position, the hole-blocking member closes the ventilation hole, and at the open position, the hole-blocking member does not close the ventilation hole to allow the air hole to be in fluid communication with the air outlet port.

In an embodiment, the child safety seat further includes: a connecting member pivotably connected to an air duct upper cover and pivotable between a first position for blocking the air outlet port and a second position for blocking the air duct.

In an embodiment, the support cushion assembly includes: a cushion body provided with a through groove; and a cushion core arranged in the through groove. A thickness of the cushion core is less than a depth of the through groove, so that when the cushion core is arranged in the through groove, the cavity is formed in the through groove.

### BRIEF DESCRIPTION OF THE DRAWINGS

The above and other objectives, features, and advantages of the present disclosure will become clearer through a more specific description of preferred embodiments of the present disclosure as shown in the accompanying drawings. Throughout the drawings, same reference numerals denote same parts, and the drawings are not deliberately drawn to scale to actual sizes. The key point is to illustrate the gist of the present disclosure.

Other features, objects and advantages of the present disclosure will become more apparent by reading a detailed description of the non-limiting embodiments with reference to the following drawings:

FIG. 1A is a schematic perspective view of a child safety seat according to an embodiment of the present disclosure;

FIG. 1B is a partial enlarged view of Part B in FIG. 1A;

FIG. 2 is a schematic structural diagram of a heating apparatus according to an embodiment of the present disclosure;

FIG. 3 is a schematic structural diagram of a seat cushion according to an embodiment of the present disclosure, in which the heating apparatus is wholly placed inside the seat cushion;

FIG. 4 is a schematic structural diagram of the seat cushion according to an embodiment of the present disclosure, in which the heating apparatus is partially placed inside the seat cushion;

FIG. 5 is a schematic perspective view of a seat according to an embodiment of the present disclosure;

FIG. 6 is a schematic perspective view of the seat shown in FIG. 5, in which an upper cover is removed;

FIG. 7 is a schematic perspective view of the seat shown in FIG. 6, in which a fan is removed;

FIG. 8 is a schematic perspective view of the seat according to an embodiment of the present disclosure;

FIG. 9 is a schematic side sectional view of the child safety seat according to an embodiment of the present disclosure;

FIG. 10 is a partial enlarged view of Part A in FIG. 9;

FIG. 11 is a schematic perspective view of a ventilation apparatus according to an embodiment of the present disclosure;

FIG. 12 is a schematic perspective view of the ventilation apparatus according to an embodiment of the present disclosure;

FIG. 13 is a schematic exploded view of the ventilation apparatus according to an embodiment of the present disclosure;

FIG. 14 is a schematic diagram of a circuit connection according to an embodiment of the present disclosure;

FIG. 15 is a schematic perspective view of the child safety seat according to an embodiment of the present disclosure;

FIG. 16 is a partial enlarged view of Part C in FIG. 15;

FIG. 17 is a schematic perspective view of the seat according to an embodiment of the present disclosure;

FIG. 18 is a partial enlarged view of Part D in FIG. 17;

FIG. 19 is another schematic perspective view of the seat according to an embodiment of the present disclosure;

FIG. 20 is a schematic perspective view of the ventilation apparatus according to an embodiment of the present disclosure;

FIG. 21 is a sectional view taken along a line E-E in FIG. 20;

FIG. 22 is a partial enlarged view of Part F in FIG. 20;

FIG. 23 is another schematic perspective view of the ventilation apparatus according to an embodiment of the present disclosure;

FIG. 24 is a schematic perspective view of the ventilation apparatus in FIG. 23, in which a cover body of a receiving box is removed;

FIG. 25 is a schematic structural diagram of a remote control according to an embodiment of the present disclosure;

FIG. 26A is a schematic perspective view of the seat according to an embodiment of the present disclosure;

FIG. 26B is a schematic perspective view after a seat cushion is mounted on the seat shown in FIG. 26A;

FIG. 27 is a schematic perspective view of the seat and a support cushion assembly according to an embodiment of the present disclosure;

FIG. 28A is a schematic perspective view of the support cushion assembly according to an embodiment of the present disclosure;

FIG. 28B is a schematic perspective view after a seat cushion is mounted on the support cushion assembly shown in FIG. 28A;

FIG. 29 is another schematic perspective view of the support cushion assembly according to an embodiment of the present disclosure;

FIG. 30 is a schematic cross-sectional view taken along an imaginary plane a in FIG. 27;

FIG. 31A is a schematic perspective view of the seat provided with a shielding sheet according to an embodiment of the present disclosure, in which the shielding sheet is at an open position;

FIG. 31B is a schematic cross-sectional view taken along an imaginary plane y in FIG. 31A, in which the shielding sheet is at a closed position;

FIG. 32 is a schematic perspective view of the seat from which the upper cover is removed according to an embodiment of the present disclosure;

FIG. 33 is a schematic perspective view of an air guide member according to an embodiment of the present disclosure;

FIG. 34 is a schematic cross-sectional view taken along an imaginary plane ß in FIG. 33;

FIG. 35A is a schematic perspective view of the seat according to an embodiment of the present disclosure, showing the seat after the shielding sheet in FIG. 31B is replaced with a cover plate, in which the cover plate is at a second position;

FIG. 35B is a schematic perspective view of the seat according to an embodiment of the present disclosure, showing the seat after the shielding sheet in FIG. 31B is replaced with the cover plate, in which the cover plate is at a first position;

FIG. 36A is a schematic perspective view of the support cushion assembly according to an embodiment of the present disclosure; and FIG. 36B is a schematic exploded view of the support cushion assembly shown in FIG. 36A.

### LIST OF REFERENCE SIGNS

10: seat, 101: upper cover, 102: accommodation cavity, 1011: first vent, 103: second fixed base, 1031: safety belt guide groove, 104: lower cover, 1041: mounting space, 120: third vent,
20: seat cushion, 201: accommodation space, 2011: positioning convex portion, 202: opening,
30: heating apparatus, 301: heating member, 302: flame-retardant member, 303: first temperature measuring apparatus, 304: heat dissipation hole, 305: connection terminal, 306: positioning concave portion,
40: control apparatus, 401: control unit, 402: operating unit, 4021: power switch, 4022: heating switch, 4023: fan switch,
50: safety apparatus,
60: ventilation apparatus, 601: first fixed base, 602: fan, 603: second temperature measuring apparatus, 6011: air duct, 6012: first guide rib, 6013: air inlet, 6014: air outlet, 6015: second guide rib, 6021: outlet, 6022: inlet, 60121: first guide space, 60151: second guide space,
70: base,
11: back, 12: seat portion,
604: air guide member, 6011: air duct, 1015: through hole, 6041: load-carrying rib, 1012: load-carrying hole, 1013: air opening, 6042: air duct upper cover, 6043: air duct lower cover, 60421: first engaging member, 60431: second engaging member, 6044: second through hole, 6045: recess, 6046: guide portion, 605: fixed plate, 6051: channel, 6052: extension portion, 1014: pore, 6053: receiving box, 6054: cover body, 6055: back section, 6056: seat section, 6057: connecting section,
4024: first indicator light, 4026: first seat angle adjustment button, 4027: second seat angle adjustment button, 4028: first fan on button, 4029: first fan off button, 60432: first mounting portion, 60422: fan mounting portion, 60423: second mounting portion,
81: shoulder strap, 82: waist strap, 83: crotch strap, 84: length adjustment strap, 85: latch,
90: remote control, 901: second indicator light, 902: third seat angle adjustment button, 903: second fan on button, 904: second fan off button, 905: fourth seat angle adjustment button,
13: support cushion assembly, 131: cushion body, 1311: through groove, 132: cushion core, 133: connecting member, 134: cavity, 135: seat cushion, 1331: air hole, 1332: windward portion, 13321: aperture, 1333: windshielding portion,
130: ventilation hole, 140: shielding sheet, 141: hole-blocking member, 6047: air outlet port.

### DETAILED DESCRIPTION

In order to facilitate understanding of the present disclosure, the present disclosure will be described more fully below with reference to the relevant drawings. Preferred embodiments of the present disclosure are given in the drawings. However, the present disclosure may be implemented in many different forms and is not limited to the embodiments described herein. Rather, these embodiments are provided to make the contents disclosed in the present disclosure more fully understood.

It is to be noted that, when one element is considered to be “connected to” another element, it may be directly connected to and integrated with the another element or an intermediate element may co-exist. The terms “mount”, “one end”, “the other end” and similar expressions used herein are for illustrative purposes only.

Unless defined otherwise, all technical and scientific terms used herein have the same meanings as would generally understood by those skilled in the technical field of the present disclosure. The terms used herein in the specification of the present disclosure are for the purpose of describing specific embodiments only, and are not intended to limit the present disclosure. The term “and/or” used herein includes any and all combinations of one or more related listed items. In the present disclosure, unless otherwise specified, the “front-rear direction” refers to a direction that a baby faces when seated in the child safety seat, and the “lateral direction” refers to a direction orthogonal to the “front-rear direction”.

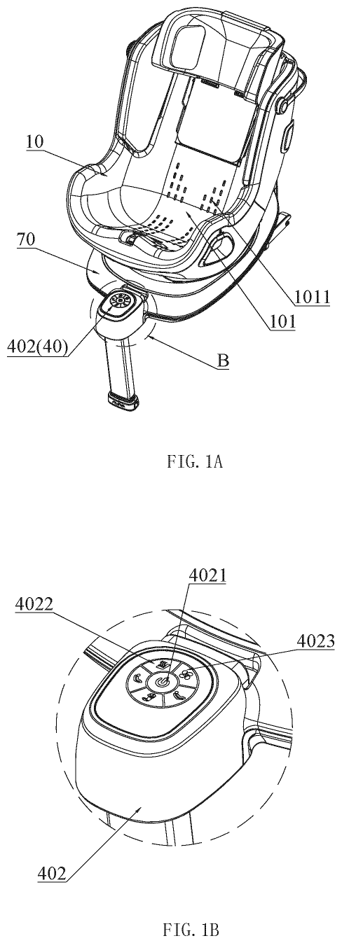

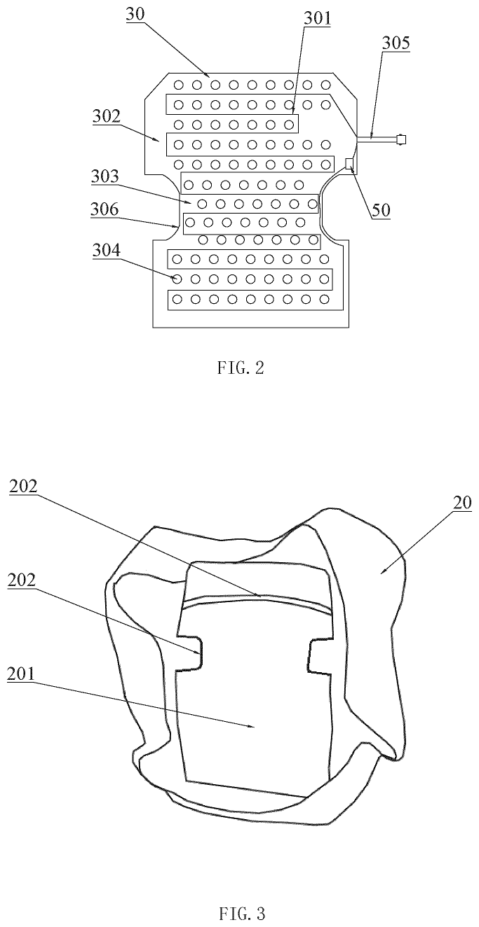

Referring to FIG. 1A, FIG. 1A is a schematic perspective view of a child safety seat according to an embodiment of the present disclosure. In an embodiment of the present disclosure, a child safety seat is provided. The child safety seat includes: a seat 10 and a base 70. The seat 10 is fixed to the base 70. A side of the seat 10 facing a child passenger sitting thereon is provided with an upper cover 101. The upper cover 101 is provided with a plurality of first vents 1011. The first vents 1011 are configured to enhance a heat exchange capability of the seat 10. For example, the first vents 1011 may increase a flow rate of hot air flowing through the seat 10 so that the seat 10 is heated more evenly. For example, the first vents 1011 may increase a flow rate of room-temperature air flowing through the seat 10 to enhance ventilation and heat dissipation of the seat 10.

Referring to FIG. 2 to FIG. 4, FIG. 2 is a schematic structural diagram of a heating apparatus according to an embodiment of the present disclosure, FIG. 3 is a schematic structural diagram of a seat cushion according to an embodiment of the present disclosure, in which the heating apparatus is wholly placed inside the seat cushion, and FIG. 4 is a schematic structural diagram of the seat cushion according to an embodiment of the present disclosure, in which the heating apparatus is partially placed inside the seat cushion. The child safety seat further includes: a seat cushion 20 detachably arranged on the seat 10; and a heating apparatus 30 detachably arranged in the seat cushion 20. Specifically, the seat cushion 20 sleeves the seat 10 and covers the upper cover 101. In this embodiment, a side of the seat cushion 20 facing the seat 10 is provided with an accommodation space 201, and the heating apparatus 30 is detachably arranged in the accommodation space 201. Specifically, an edge of the heating apparatus 30 may be provided with a positioning concave portion 301, an edge of the accommodation space is provided with a positioning convex portion 2011, and the heating apparatus 30 is fixed in the accommodation space through shape fit of the positioning concave portion and the positioning convex portion. The accommodation space 201 is provided with an openable and closable opening 202, and the heating apparatus 30 is loaded into the accommodation space 201 or removed from the accommodation space 201 through the opening 202. Optionally, the opening 202 is opened and closed by a zipper apparatus. Those skilled in the art should understand that the arrangement of the accommodation space 201 on the seat cushion 20 is only exemplary, and the heating apparatus 30 may alternatively be detachably arranged in the seat cushion in other manners, such as by snap-fit connection, magnetic connection, or buckle connection, which is not limited in the present disclosure.

Referring to FIG. 2, the heating apparatus 30 includes: a heating member 301, a flame-retardant member 302, and a connection terminal 305. The heating member 301 is arranged in the flame-retardant member 302 and is electrically connected to the connection terminal 305. In this embodiment, the heating member 301 may be a heating wire made of metal and/or carbon fiber, or may be a heating mesh made of graphene. Optionally, the heating member 301 may alternatively be a heating sheet, a heating rod, or the like, which is not limited in the present disclosure. In this embodiment, the flame-retardant member 302 is a hollow sheet-like element, and the heating wire is arranged in the sheet-like element. Optionally, the flame-retardant member 302 may alternatively be in another suitable shape, such as a strip or a rod, which is not limited in the present disclosure. The flame-retardant member 302 serves as a carrier of the heating apparatus 30 and provides insulation protection for the heating member 301 arranged therein. Further, the flame-retardant member 302 further allows heat generated by the heating member 301 to be evenly dissipated outwards. After the flame-retardant member 302 stops heating, the flame-retardant member 302 may continue to dissipate waste heat of the heating member 301 outwards evenly, preventing a rapid drop in the temperature of the seat temperature, thereby improving comfort of use. In this embodiment, the flame-retardant member 302 is made of white fibers. Optionally, the flame-retardant member 302 may alternatively be made of another suitable material, such as asbestos, which is not limited in the present disclosure.

In the embodiment shown in FIG. 2, the heating apparatus 30 further includes a first temperature measuring apparatus 303 arranged on the flame-retardant member 302 and arranged at the heating member 301. The first temperature measuring apparatus 303 is communicably connected to the control apparatus 40, and the first temperature measuring apparatus 303 is configured to measure a real-time temperature of the heating apparatus 30. Specifically, the first temperature measuring apparatus 303 is a temperature sensor or a temperature detection chip. The temperature sensor is arranged on the flame-retardant member 302 to measure the real-time temperature of the heating apparatus 30. It is to be noted that although FIG. 2 shows that the first temperature measuring apparatus 303 is arranged in the middle of the flame-retardant member 302, this is only exemplary. Those skilled in the art may select the arrangement position of the first temperature measuring apparatus 303 according to an actual requirement. For example, the first temperature measuring apparatus 303 may be arranged on an upper portion of the flame-retardant member 302. Optionally, the first temperature measuring apparatus 303 may alternatively be arranged outside the heating apparatus 30, for example, arranged in a portion of the seat cushion 20 close to the heating member 301, or arranged in a portion of the seat 10 near the heating apparatus 30. Optionally, a plurality of first temperature measuring apparatuses 303 may be arranged on the flame-retardant member 302, and the control apparatus 40 evaluates the real-time temperature of the heating apparatus 30 through temperatures measured by the plurality of first temperature measuring apparatuses 303.

In the embodiment shown in FIG. 2, the heating apparatus 30 further includes a plurality of heat dissipation holes 304 arranged in the flame-retardant member 302. The heat dissipation holes 304 are configured to enhance a heat dissipation capability of the heating apparatus 30, which helps to transfer heat generated by the heating member 301 to the seat cushion 20 and then to the seat 10. Preferably, the plurality of heat dissipation holes 304 are evenly arranged at equal intervals along an extension direction of the heating member 301. It is to be noted that the number and the arrangement of the heat dissipation holes 304 shown in FIG. 2 are exemplary. Those skilled in the art may select the number and the arrangement of the heat dissipation holes 304 according to an actual requirement.

Referring to FIG. 1A, FIG. 2, and FIG. 14, FIG. 14 is a schematic diagram of a circuit connection according to an embodiment of the present disclosure. The child safety seat further includes: a control apparatus 40 at least partially arranged in the seat 10, and the heating member 301 is electrically connected to the control apparatus 40 via the connection terminal 305. In this embodiment, the control apparatus 40 includes: a control unit 401 (refer to FIG. 10) arranged in the seat 10, and the heating apparatus 30 is electrically connected to the control unit 401. The first temperature measuring apparatus 303 is communicably connected to the control unit 401. The control unit 401 is configured such that the control unit 401 controls the heating member 301 to stop heating when a temperature measured by the first temperature measuring apparatus 303 reaches a second preset temperature. Optionally, the control unit 401 is configured such that the control unit 401 controls the heating member 301 to start heating or allows the heating member 301 to continue heating when the temperature measured by the first temperature measuring apparatus 303 is lower than the second preset temperature. Optionally, the second preset temperature is adjustable. Optionally, the control unit 401 is a control circuit board. An arrangement position of the control unit 401 will be described in detail later.

Referring to FIG. 1A, the control apparatus 40 further includes: an operating unit 402 arranged on the child safety seat and communicably connected to the control unit 401. The operating unit 402 is configured to adjust an operating state of the heating apparatus 30. In the embodiment shown in FIG. 1A, the operating unit 402 is arranged on a base 70. Optionally, the operating unit 402 may alternatively be arranged at any suitable position of the child safety seat according to a usage requirement, for example, on the seat 10. The operating unit 402 includes at least one switch. The at least one switch is configured to control ON and OFF of the heating member 301. Optionally, the operating unit 402 includes at least a main power switch and a heating switch. The main power switch is configured to control ON and OFF of the control unit 401. The heating switch is configured to control ON and OFF of the heating member 301.

Referring to FIG. 1B, FIG. 1B is a partial enlarged view of Part B in FIG. 1A. In an embodiment, the operating unit 402 includes a power switch 4021, a heating switch 4022, and a fan switch 4023. The power switch 4021 is the main power switch of the child safety seat and is configured to control power on and power off of the control unit 401. The heating switch 4022 is configured to control ON and OFF of a heating function of the child safety seat. The fan switch 4023 is configured to control ON and OFF of a ventilation function of the child safety seat. Optionally, switch forms of the power switch 4021, the heating switch 4022, and the fan switch 4023 may be the same or different. Optionally, the switch forms include touch switches, button switches, and the like.

Optionally, in an embodiment, the control apparatus 40 further includes: a wireless communication module (not shown). The control unit 401 is wirelessly and communicably connected to an external device through the wireless communication module, and the external device is configured to adjust the operating state of the heating apparatus 30. Optionally, the wireless communication module includes a WIFI (wireless local area network) communication module, a Bluetooth communication module, a near field communication (NFC) communication module, and the like. Optionally, the external device includes smart terminals such as mobile phones and tablet computers. After the control unit 401 is wirelessly and communicably connected to the external device through the wireless communication module, through application software running on the external device, operating parameters of the heating apparatus 30 may be set and the operating state of the heating apparatus 30 may be controlled.

A Bluetooth communication module and a mobile phone are taken as examples below to describe an operating mode of the heating apparatus 30 provided in the embodiments of the present disclosure. After the control unit 401 is wirelessly and communicably connected to the mobile phone through the Bluetooth communication module, a user may set operating parameters of the heating apparatus 30 and control the operating state of the heating apparatus 30 through an application program running on the mobile phone. For example, the user may control ON or OFF of the heating member 301 through the application program running on the mobile phone. For example, the user may set the second preset temperature to, for example, 40° C. through the application program running on the mobile phone. Specifically, when the heating member 301 is in an on state, if the temperature measured by the first temperature measuring apparatus 303 is lower than 40° C., the control unit 401 allows the heating member 301 to continue heating, and if the temperature measured by the first temperature measuring apparatus 303 is higher than or equal to 40° C., the control unit 401 controls the heating member 301 to stop heating. When the heating member 301 is in an off state, if the temperature measured by the first temperature measuring apparatus 303 is lower than 40° C., the control unit 401 allows the heating member 301 to start heating.

Referring to FIG. 2 and FIG. 14, the child safety seat further includes: a thermal safety apparatus 50 arranged on the heating apparatus 30 and configured to cause the heating apparatus 30 to stop heating when the heating apparatus 30 reaches a first preset temperature. A maximum value of the second preset temperature is less than the first preset temperature. Specifically, when the heating apparatus 30 operates, if the temperature of the heating apparatus 30 exceeds the first preset temperature, for example, exceeds 60° C., the thermal safety apparatus 50 may break, thereby cutting off an electrical circuit of the heating member 301, causing the heating member 301 to stop heating. The thermal safety apparatus 50 is configured to prevent overheating of the heating apparatus 30, which may prevent damages to the heating apparatus 30 or other components of the child safety seat due to overheating and may also prevent injuries to the child passenger sitting in the child safety seat due to overheating of the seat cushion 20. In the embodiment shown in FIG. 14, the thermal safety apparatus 50 is arranged between the control apparatus 40 and the heating member 301, but this is only exemplary. Those skilled in the art may arrange the thermal safety apparatus 50 at any appropriate position in the circuit as required, as long as a requirement for cutting off the electrical circuit of the heating member 301 through the thermal safety apparatus 50 is met. Preferably, the thermal safety apparatus 50 is a resettable thermal fuse, which is connected in series in the electrical circuit of the heating member 301. The resettable fuse is limited to a first preset temperature, a resettable temperature, and a resettable time. When the temperature of the heating apparatus 30 exceeds the first preset temperature, the resettable fuse will break, thereby cutting off the electrical circuit of the heating member 301 so that the heating member 301 stops heating. When the temperature of the heating apparatus 30 remains below the resettable temperature for a period of time longer than the resettable time, the resettable fuse will resume conduction of a current. Optionally, the thermal safety apparatus 50 may alternatively be a disposable fuse. When the temperature of the heating apparatus 30 exceeds the first preset temperature, the disposable fuse will blow, thereby cutting off the electrical circuit of the heating member 301. Replacing the disposable fuse can resume the conduction of the current.

The thermal safety apparatus 50 may realize circuit breaking independently, which is particularly advantageous for certain extreme situations. For example, in a case where the control apparatus 30 fails, the control apparatus 30 does not control the heating member 301 to stop heating when the heating apparatus 30 exceeds the second preset temperature, thereby causing the heating member 301 to continue heating, so that the temperature of the control apparatus 30 rises above the first preset temperature. In this case, the thermal safety apparatus 50 breaks, cutting off the electrical circuit of the heating member 301 and causing the heating member 301 to stop heating, thereby realizing a “safety” function.

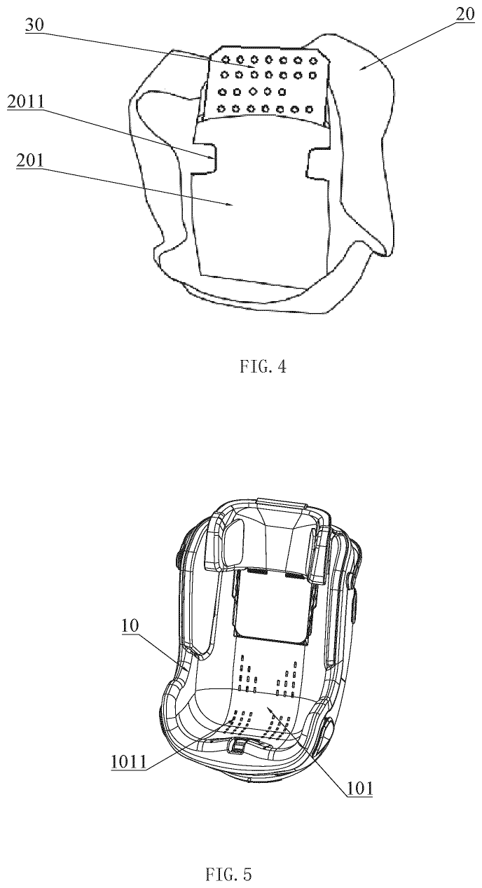

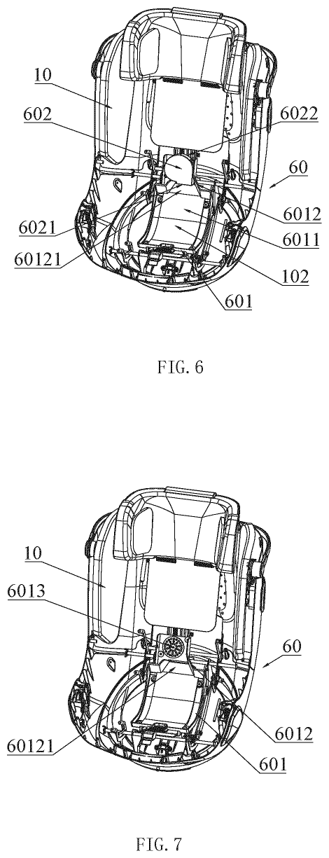

Referring to FIG. 5 to FIG. 7 and FIG. 14, FIG. 5 is a schematic perspective view of a seat according to an embodiment of the present disclosure; FIG. 6 is a schematic perspective view of the seat shown in FIG. 5, in which an upper cover is removed; and FIG. 7 is a schematic perspective view of the seat shown in FIG. 6, in which a fan is removed. In an embodiment, the child safety seat further includes: a ventilation apparatus 60 arranged in the seat 10 and electrically connected to the control apparatus 40. The ventilation apparatus 60 is configured to form air flow inside the seat 10 to reduce the temperature of the seat 10. Referring to FIG. 5 and FIG. 6, an accommodation cavity 102 is defined in the seat 10, the upper cover 101 is arranged to cover the accommodation cavity 102, and the ventilation apparatus 60 is arranged in the accommodation cavity 102. The ventilation apparatus 60 includes: a first fixed base 601 fixedly arranged in the accommodation cavity 102, an air duct 6011 being formed between the first fixed base 601 and the upper cover 101; and a fan 602 fixedly arranged on the first fixed base 601 and electrically connected to the control apparatus 40. An outlet 6021 of the fan 602 is in fluid communication with the air duct 6011. Room-temperature air driven by the fan 602 flows through the air duct 6011 and the first vents 1011 of the upper cover 101 into a region where the seat cushion 20 is located, to reduce the temperature of the seat cushion. In this embodiment, the air duct 6011 formed between the first fixed base 601 and the upper cover 101 defines a ventilation region on a side of the upper cover 101 facing away from the seat cushion 20. The ventilation region corresponds to at least part of a lower portion of the seat cushion 20. The room-temperature air driven by the fan 602 flows intensively in the region and flows out from the first vent 1011 to the seat cushion 20, and the airflow gathers in the part of the seat cushion 20 corresponding to the ventilation region, so the cooling is more targeted and more effective.

Referring to FIG. 7, FIG. 9, and FIG. 10, FIG. 9 is a schematic side sectional view of the child safety seat according to an embodiment of the present disclosure; and FIG. 10 is a partial enlarged view of Part A in FIG. 9. In an embodiment, the first fixed base 601 is provided with an air inlet 6013 and an air outlet 6014. The air inlet 6013 is in fluid communication with a third vent 120 at a backrest of the seat 10, and the air outlet 6014 is in fluid communication with the air duct 6011. Optionally, the air inlet 6013 is arranged at a portion of the first fixed base 601 close to the inlet 6022 of the fan 602. The arrangement of the air inlet 6013 can increase an air intake volume of the fan 602, thereby increasing an amount of air for cooling, to improve a cooling effect. It is to be noted that the number and the arrangement of the heat air inlet 6013 shown in FIG. 7 are both exemplary. Those skilled in the art may select the number and the arrangement of the air inlet 6013 according to an actual requirement, for example, the number and the arrangement of the inlet 6022 of the fan 602.

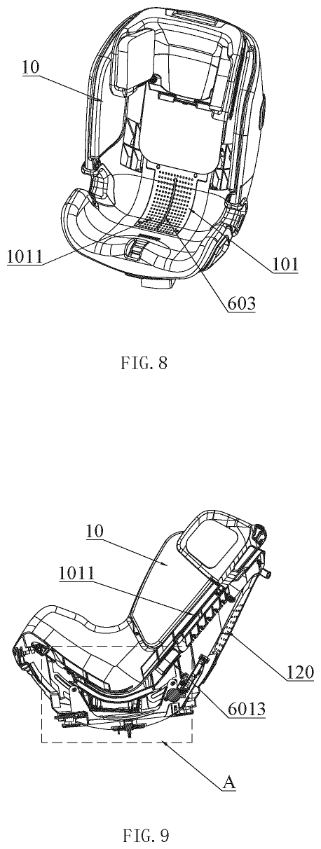

Referring to FIG. 7 and FIG. 8, in an embodiment, the air duct 6011 is recessed in a direction away from the seat cushion 20 to define a ventilation region on a side of the upper cover 101 facing away from the seat cushion 20. The ventilation region corresponds to at least part of a lower portion of the seat cushion 20. The room-temperature air driven by the fan 602 flows intensively in the region and flows out from the first vent 1011 to the seat cushion 20, and the airflow gathers in the part of the seat cushion 20 corresponding to the ventilation region, so the cooling is more targeted and more effective. Further, a height of the air duct 6011 in an air circulation direction is less than a height of the air outlet 6014, so a space required by the air duct 6011 is smaller. Therefore, the first fixed base 601 occupies a smaller space, and an overall structure of the seat 10 is more compact. Further, a cross-sectional area of the air duct 6011 in the air circulation direction is larger than a cross-sectional area of the air outlet 6014, so that a flow rate of the airflow entering the air duct 6011 is reduced and pressure on a surrounding environment is increased, thereby improving a gas exchange capability and improving the cooling effect.

The first fixed base 601 further includes: a first guide rib 6012 arranged at an end of the first fixed base 601 close to the air outlet 6014. The first guide rib 6012 defines a first guide space 60121 between the air outlet 6014 and the air duct 6011. The first guide space 60121 is configured such that a cross-sectional area of the first guide space 60121 gradually becomes larger along a direction from the air outlet 6014 to the air duct 6011. Therefore, a flow rate of the airflow passing through the first guide space 60121 is reduced, and the pressure on the surrounding environment is greatly increased, thereby improving the gas exchange capability and improving the cooling effect. In addition, the guide space 60121 defined by the first guide rib 6012 guides the airflow flowing out of the outlet 6021 so that the airflow flows to the air duct 6011 as much as possible, to cool the part of the seat cushion 20 corresponding to the ventilation region. Therefore, the arrangement of the first guide rib 6012 improves utilization of the airflow and further improves the cooling effect. Referring to FIG. 8, in an embodiment, the ventilation apparatus 60 further includes: a second temperature measuring apparatus 603 arranged on the upper cover 101 and communicably connected to the control apparatus 40. The second temperature measuring apparatus 603 is configured to measure a real-time temperature of the seat 10. Specifically, the second temperature measuring apparatus 603 is a temperature sensor. The temperature sensor is arranged in the upper cover 101 to measure a real-time temperature near the upper cover 101 and the seat cushion 20. It is to be noted that although FIG. 8 shows that the second temperature measuring apparatus 603 is arranged in the middle of the upper cover 101 and has an elongated structure, this is only exemplary. Those skilled in the art may select the arrangement position and the shape of the second temperature measuring apparatus 603 according to an actual requirement. For example, the second temperature measuring apparatus 603 may be arranged on a side portion of the upper cover. Optionally, the second temperature measuring apparatus 603 may be in another shape, such as a circle or a rectangle. Optionally, a plurality of second temperature measuring apparatuses 603 may be arranged on the upper cover 101, and the control apparatus 40 evaluates a current real-time temperature near the seat cushion 20 through temperatures measured by the plurality of second temperature measuring apparatuses 603.

In an embodiment, the fan 602 is electrically connected to the control unit 401. The second temperature measuring apparatus 603 is communicably connected to the control unit 401. The control unit 401 is configured such that the control unit 401 controls the fan 602 to stop ventilation when a temperature measured by the second temperature measuring apparatus 603 is lower than a third preset temperature; and/or the control unit 401 controls the fan 602 to start ventilation or allows the fan to continue ventilation when the temperature measured by the second temperature measuring apparatus 603 reaches the third preset temperature.

Referring to FIG. 1A and FIG. 8, the operating unit 402 is configured to adjust an operating state of the ventilation apparatus 60. In the embodiment shown in FIG. 8, the position of the operating unit 402 may be similar to that in the embodiment shown in FIG. 1A. The operating unit 402 includes at least one switch. The at least one switch is configured to control ON and OFF of the fan 602. Optionally, the operating unit 402 includes a ventilation switch. The ventilation switch is configured to control ON and OFF of the fan 602.

Optionally, in the embodiment shown in FIG. 8, the control unit 401 further includes: a wireless communication module. The wireless communication module may be similar to the wireless communication module in the embodiment shown in FIG. 1A. After the control unit 401 is wirelessly and communicably connected to an external device through the wireless communication module, through application software running on the external device, operating parameters of the ventilation apparatus 60 may be set and the operating state of the ventilation apparatus 60 may be controlled.

A Bluetooth communication module and a mobile phone are taken as examples below to describe an operating mode of the ventilation apparatus 60 provided in the embodiments of the present disclosure. After the control unit 401 is wirelessly and communicably connected to the mobile phone through the Bluetooth communication module, the user may set operating parameters of the ventilation apparatus 60 and control the operating state of the ventilation apparatus 60 through an application program running on the mobile phone. For example, the user may control ON and OFF of the ventilation apparatus 60 through the application program running on the mobile phone. For example, the user may set the third preset temperature to, for example, 30° C. through the application program running on the mobile phone. Specifically, when the fan 602 is in an on state, if the temperature measured by the second temperature measuring apparatus 603 is lower than 30° C., the control unit 401 controls the fan 602 to be turned off, and if the temperature measured by the second temperature measuring apparatus 603 is higher than or equal to 30° C., the control unit 401 allows the fan 602 to continue operating. When the fan 602 is in an off state, if the temperature measured by the first temperature measuring apparatus 303 is higher than or equal to 30° C., the control unit 401 controls the fan 602 to start.

Referring to FIG. 9 and FIG. 10, in an embodiment, a second fixed base 103 is further arranged in the accommodation cavity 102. The second fixed base 103 is fixedly connected to a side of the first fixed base 601 facing away from the upper cover 101. A safety belt guide groove 1031 is defined between the second fixed base 103 and the first fixed base 601. Specifically, the safety belt guide groove 1031 is adapted to allow a safety belt to pass therethrough. On the one hand, the safety belt guide groove 1031 provides a passage path for the safety belt to facilitate layout of the safety belt in the child safety seat. On the other hand, the safety belt guide groove 1031 and the safety belt passing therethrough isolate the air duct 6011 above the safety belt guide groove 1031 from components below the safety belt guide groove 1031, to ensure the safe operation of the components below the safety belt guide groove 1031, which will be continuously described below.

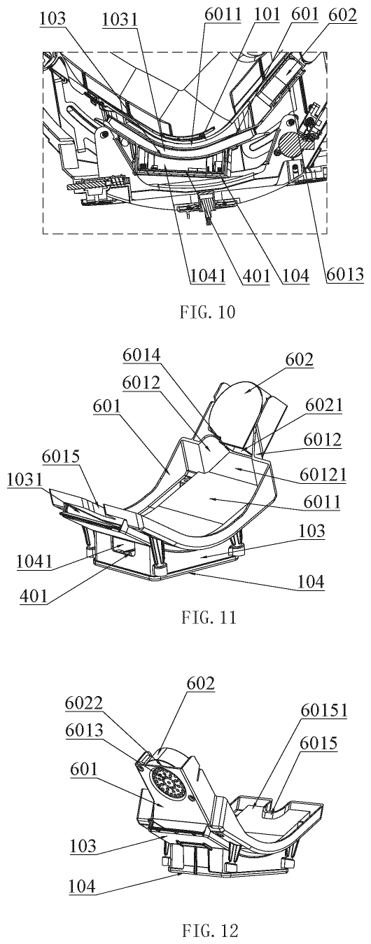

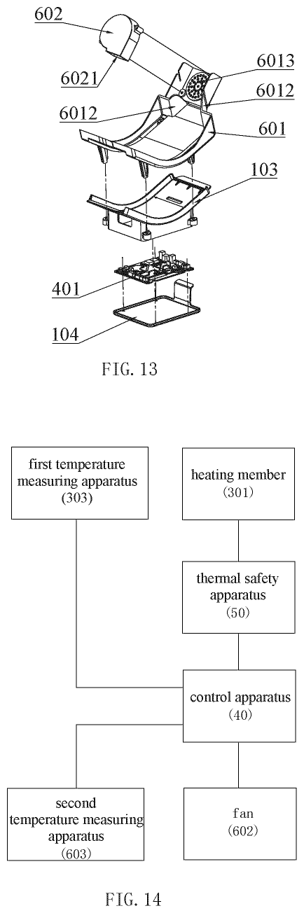

Referring to FIG. 11 to FIG. 13, in an embodiment, the first fixed base 601 further includes: a second guide rib 6015 arranged at an end of the first fixed base 601 away from the air outlet 6014. The second guide rib 6015 defines a second guide space 60151 in the air duct 6011. The second guide space 60151 is configured such that a cross-sectional area of the second guide space 60151 gradually decreases along the direction from the air outlet 6014 to the air duct 6011. Therefore, a flow rate of the airflow passing through the second guide space 60151 is reduced, and the pressure on the surrounding environment is greatly increased, thereby improving the gas exchange capability and improving the cooling effect. Specifically, the second guide rib 6015 has a U-shaped structure, and the second guide rib 6015 is arranged at a position opposite to the air outlet 6014. The U-shaped portion of the second guide rib 6015 is in communication with the safety belt guide groove 1031. After passing through the safety belt guide groove 1031, the safety belt (crotch strap) passes through the U-shaped portion of the second guide rib 6015 and then further passes through a crotch strap opening portion of the upper cover 101, thereby preventing an excessively large bending angle of the crotch strap between the safety belt guide groove 1031 and the crotch strap opening portion. A lower cover 104 is further arranged in the accommodation cavity 102. The lower cover 104 is connected to a side of the second fixed base 103 facing away from the first fixed base 601. A mounting space 1041 is defined between the lower cover 104 and the second fixed base 103, and the control unit 401 is fixedly arranged in the mounting space 1041. In this embodiment, the side of the second fixed base 103 facing away from the first fixed base 601 extends in a direction away from the first fixed base 601 to form a hollow structure, and the lower cover 104 and the hollow structure together define the mounting space 1041. The control unit 401 is fixedly arranged on the lower cover 104 to be accommodated in the mounting space 1041. Optionally, the control unit 401 is a control circuit board. In this embodiment, the fan 602 and the air duct 6011 are arranged above the safety belt guide groove 1031, and the control unit 401 is arranged in the mounting space 1041 below the safety belt guide groove 1031. Therefore, the safety belt guide groove 1031 and the safety belt passing therethrough isolate the air duct 6011 above the safety belt guide groove 1031 from the control unit 401 arranged in the mounting space 1041 below the safety belt guide groove 1031, to prevent damages to the control unit 401 caused by contact of other components of the child safety seat or foreign matter in the air sucked by the fan 602 with the control unit 401.

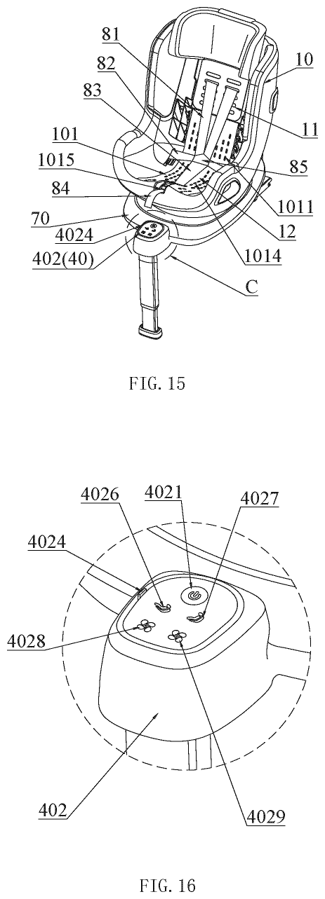

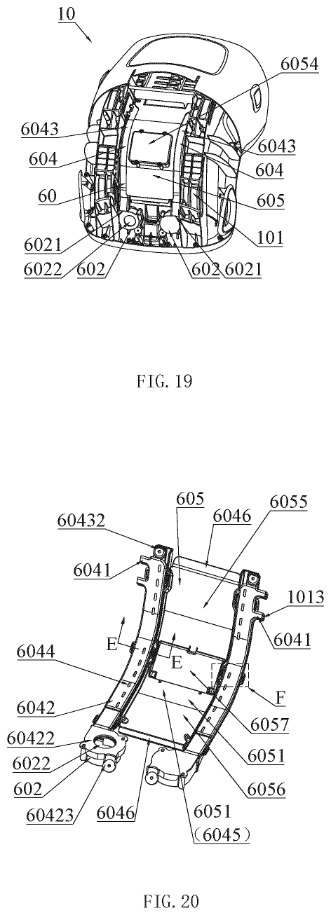

Referring to FIG. 15, FIG. 17, and FIG. 19, in an embodiment, a child safety seat is further provided, including a seat 10 including an upper cover 101; a plurality of fans 602; and a plurality of air guide members 604. The plurality of air guide members 604 are in fluid communication with the plurality of fans 602 respectively. Air flow is formed inside the seat 10 through the fan 602 and the air guide member 604 to reduce the temperature of the seat 10 and provide comfortable experience for the user.

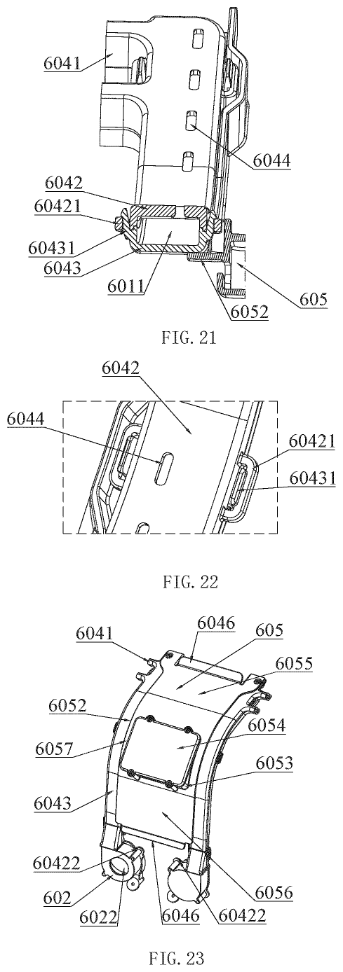

Referring to FIG. 20 and FIG. 21, in an embodiment, the air guide member 604 is provided with a hollow air duct 6011 and a plurality of second vents 6044. The second vents 6044 are arranged on at least one side facing the upper cover 101 and are in fluid communication with the air duct 6011. The fan 602 drives the air to pass through the air duct 6011 of the air guide member 604 and flow out from the second vent 6044. The flowing air can reduce a temperature of a region near the upper cover 101 of the seat 10. The air guide member 604 and the air duct 6011 are basically straight lines along a front-rear direction of the seat 10 to reduce noise caused by large-angle bending of the air duct.

Referring to FIG. 17 and FIG. 19, in an embodiment, the plurality of air guide members 604 are located on two sides of the upper cover 101 respectively, and the plurality of air guide members 604 and the upper cover 101 form a recess 6045. Those skilled in the art may understand that a combination of the plurality of independent air guide members and the plurality of fans can ensure airflow pressure at the air outlet and also effectively reduce the operation of the fan and the noise of the air duct. The arrangement of the plurality of air guide members 604 on two sides of the upper cover can maximize a contact area while ensuring strong air outlet pressure, so as to improve heat dissipation efficiency. In this embodiment, two air guide members 604 are provided, each air guide member 604 is connected to one fan, and air ducts of the two air guide members 604 are independent of each other to prevent loss of wind pressure due to mutual interference between the fans. The fan is connected to a front end of the air guide member 604, that is, the end away from the backrest of the seat. The carrying rib 6041 is located at a back end of the air guide member 604, that is, the end close to the backrest of the seat. A general region of the recess 6045 is exemplarily shown by dash-dotted lines in FIG. 17. Specifically, opposite edges of the air guide members 604 located on two sides of the upper cover 101 and the upper cover 101 jointly define the recess 6045. The recess 6045 is adapted to provide guidance and accommodation spaces for the safety belt of the child safety seat. Referring to FIG. 15 and FIG. 17 together, FIG. 15 exemplarily shows a structure of the safety belt of the child safety seat exposed from the seat 10, and FIG. 17 exemplarily shows a structure of the safety belt of the child safety seat located on a back side of the upper cover 101 (inside the seat 10) with dash-dotted lines. For example, the safety belt includes: a shoulder strap 81, a waist strap 82, a crotch strap 83, and a latch 85. The shoulder strap 81, the waist strap 82, and the crotch strap 83 may be locked by the latch 85 (e.g., a five-point buckle). The shoulder strap 81 penetrates from a safety belt hole in a back 11 of the seat 10 into the back side of the upper cover 101 (i.e., enters the interior of the seat 10), passes through the recess 6045, and passes through a through hole 1015 provided in the upper cover 101, so that a tail end of the shoulder strap 81 is exposed from the upper cover 101. A length adjustment strap 84 is formed at the tail end of the shoulder strap 81 exposed from the upper cover 101. The user adjusts a length of the shoulder strap 81 by pulling the length adjustment strap 84. In this embodiment, the recess 6045 provides at least limiting and guiding functions for the shoulder strap 81. The through hole 1015 is in communication with the recess 6045. Preferably, the through hole 1015 is arranged at a front end of the seat portion 12 of the seat 10, and the fans 602 are spaced apart from each other, leaving a gap for guidance. A width of the gap is less than a width of the recess 6045. The length adjustment strap 84 passes through the gap in the fan 602 before passing through the through hole 1015.

Referring to FIG. 19 and FIG. 20, in an embodiment, the child safety seat further includes a fixed plate 605, the fixed plate 605 is fixedly connected to at least two air guide members 604 of the plurality of air guide members 604, and the fixed plate 605 forms a channel 6051 with the recess 6045. Specifically, the fixed plate 605 covers a side of the recess 6045 away from the upper cover 101 to form a channel 6051 together with the recess 6045, and a region of the channel 6051 is approximately the same as a region of the recess 6045 (e.g., a region between the dash-dotted lines in FIG. 17). In this embodiment, the channel 6051 extends from the top of the backrest of the seat 10 to the through hole 1015 located at the front end of the seat 10, and the through hole 1015 is in communication with the channel 6051. Through the formation of the channel 6051, accidental contact of the shoulder strap 81 limited and guided in the recess 6045 with other components inside the seat 10 can be prevented, ensuring smooth guidance of the shoulder strap 81. It is to be noted that guiding the shoulder strap 81 through the recess 6045 or the channel 6051 is only exemplary, and other components of the safety belt, such as the crotch strap, the waist strap, and energized wires, may also be guided through the recess 6045 or the channel 6051, which is not limited in the present disclosure.

Referring to FIG. 20, in an embodiment, a guide portion 6046 is arranged at an end of the fixed plate 605 in a vertical direction, and the guide portion 6046 is adapted to fit the upper cover 101 to form a guide opening for the safety belt. Preferably, guide portions 6046 are arranged at two ends of the fixed plate 605 in the vertical direction. Optionally, the guide portion 6046 is a plate-shaped structure protruding from an edge of the fixed plate 605 in the vertical direction in a direction away from the fixed plate 605.

Referring to FIG. 19 to FIG. 21, in an embodiment, the fixed plate 605 is arranged to extend from the back 11 of the seat 10 to the seat portion 12 of the seat 10, and the fixed plate 605 includes: a back section 6055, a seat section 6056, and a connecting section 6057. The back section 6055 is arranged, for example, on the back 11 of the seat 10. The seat section 6056 is arranged, for example, on the seat portion 12 of the seat 10. The connecting section 6057 is connected between the back section 6055 and the seat section 6056. Optionally, a shape of the connecting section 6057 matches a shape of the corresponding portion of the upper cover 101. Preferably, the connecting section 6057 is configured in an arc shape. Optionally, the air guide member 604 is provided as an elongated structure and extends from the back of the seat 10 to the seat portion of the seat 10. The elongated air guide member 604, on the one hand, can ensure wind pressure of the flowing air in the air duct 6011, and on the other hand, can cover a region from the back 11 of the seat 10 to the seat portion 12 as much as possible, so as to increase an area of a heat dissipation region and optimize a heat dissipation effect. Further, curvature of the air guide member 604 is less than 90 degrees to reduce loss of the passing airflow and increase the air outlet pressure at the vents (for example, the second vent 6044 and a ventilation opening 1019).

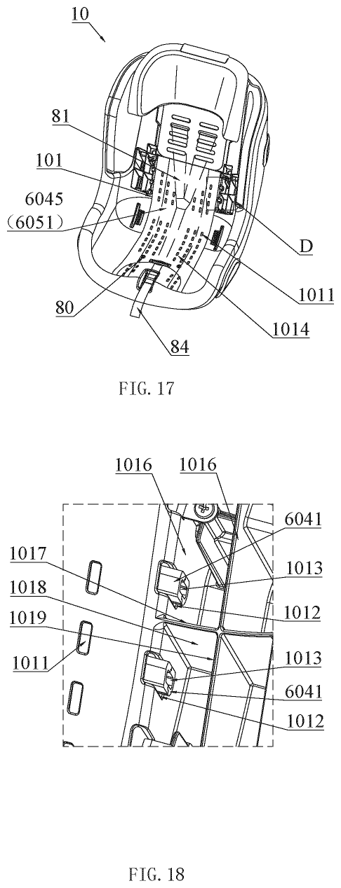

Referring to FIG. 17 and FIG. 18, in an embodiment, the air guide member 604 is provided with a carrying rib 6041, the upper cover 101 is provided with a first rib 1016 extending along a vertical direction, a carrying hole 1012 is arranged in a side wall of the first rib 1016, and the carrying rib 6041 is inserted into the carrying hole 1012 to be fixed to the upper cover 101, improving space utilization in a height direction. In addition, since resonance may occur between the plurality of independent air guide members, which may cause fixed screws to loosen, the insertion and fixation manner can improve an anti-resonance capability of the air guide member and improve stability of a fixed connection. Optionally, an end of the carrying rib 6041 that passes through the carrying hole 1012 is provided with an air opening 1013, and the air opening 1013 is in fluid communication with the air duct 6011. Through the arrangement of the air opening 1013, the flowing air in the air duct 6011 flows out from the air opening 1013 to reduce a temperature of a region of the upper cover 101 near the air opening 1013, thereby improving the heat dissipation effect. Optionally, the upper cover 101 is further provided with a second rib 1017 extending along a horizontal direction, and the first rib 1016 and the second rib 1017 form a reinforcing groove 1018 in the upper cover 101. In the reinforcing groove 1018, the first rib 1016 and the second rib 1017 intersect each other to form a cavity structure. The reinforcing groove 1018 is further provided with the ventilation opening 1019, and the air opening 1013 is in fluid communication with the upper cover 101 through the ventilation opening 1019. In this embodiment, on the one hand, structural strength near the carrying hole 1012 is strengthened through the formation of the reinforcing groove 1018, so as to ensure support for the carrying rib 6041, and on the other hand, the cavity structure in the reinforcing groove 1018 increases an air outlet area, resulting in more vacant space near the air opening 1013 and less resistance to air flow. In some embodiments, at least part of the vents (e.g., the second vents 6044 and the ventilation opening 1019) are arranged adjacent to two wings of the seat 10 to ensure that the vents are not completely covered by the baby's buttocks, thereby increasing efficiency of air outlet.

Referring to FIG. 17 and FIG. 18, in an embodiment, the upper cover 101 is provided with a plurality of first vents 1011 located above the air guide members 604 and pores 1014 located above the recess between the air guide members 604. Optionally, the first vent 1011 and the second vent 6044 of the air guide member 604 are arranged to overlap, so that the flowing air in the air duct 6011 can flow out to an upper surface of the upper cover 101, and hot air on the upper surface of the upper cover 101 can flow into the pores 1014 above the recess, to enhance the heat dissipation effect. In some embodiments, referring to FIG. 20, the air guide member 604 on the left side discharges air towards the upper surface of the upper cover 101 through the first vent 1011, and the air guide member 604 on the right side draws air from the upper surface of the upper cover 101 through the first vent 1011. In some other embodiments (not shown), more than two air guide members are arranged on the left and right sides of the seat respectively. In the air guide members on the left side, one part of the air guide members discharge air towards the upper surface of the upper cover through the first vents, and the other part of the air guide members draw air from the upper surface of the upper cover through the first vents, to form an air flow circulation system on the left side. In the air guide members on the right side, one part of the air guide members discharge air towards the upper surface of the upper cover through the first vents, and the other part of the air guide members draw air from the upper surface of the upper cover through the first vents, to form an air flow circulation system on the right side.

Referring to FIG. 20 to FIG. 22, in an embodiment, the air guide member 604 includes: an air duct upper cover 6042 and an air duct lower cover 6043, and the air duct lower cover 6043 and the air duct upper cover 6042 are inserted into and engaged with each other to form the air duct 6011. The air duct upper cover 6042 is arranged on a side of the air guide member 604 close to the upper cover 101, and the second vent 6044 is arranged on the air duct upper cover 6042. The air duct lower cover 6043 is arranged on a side of the air guide member 604 facing away from the upper cover 101. The fan 602 is fixedly connected to the air duct upper cover 6042, and the air duct upper cover 6042 is fixedly connected to the upper cover 101. Optionally, a first mounting portion 60432 is arranged at an end of the air duct upper cover 6042 away from the fan 602, and the air duct upper cover 6042 is fixedly connected to the upper cover 101 through the first mounting portion 60432. Specifically, the first mounting portion 60432 is provided with a screw hole, and the air duct upper cover 6042 is fixedly connected to the upper cover 101 through a screw inserted into the screw hole.

In an embodiment, the air duct upper cover 6042 and the air duct lower cover 6043 are fastened to each other through an engaging member. Specifically, referring to FIG. 21, a side edge of the air duct upper cover 6042 includes a first engaging member 60421, a side edge of the air duct lower cover 6043 includes a second engaging member 60431, and when the air duct lower cover 6043 and the air duct upper cover 6042 are fastened to each other, the first engaging member 60421 is engaged with the second engaging member 60431 to fixedly connect the air duct lower cover 6043 to the air duct upper cover 6042. Optionally, one of the first engaging member 60421 and the second engaging member 60431 is a snap protrusion, and the other is a snap ring. Those skilled in the art should understand that the fact that the air duct upper cover 6042 and the air duct lower cover 6043 are fastened to each other through the engaging member is only exemplary, and the air duct upper cover 6042 and the air duct lower cover 6043 may alternatively be fastened to each other in another suitable manner, such as buckle connection, magnetic connection, or thermal welding.

Referring to FIG. 20 and FIG. 21, in an embodiment, the fixed plate 605 is arranged on an inner side of the upper cover 101 and covers at least part of the air duct lower cover 6043. Optionally, a side edge of the fixed plate 605 is provided with an extension portion 6052, and the extension portion 6052 covers and supports the air duct lower cover 6043. In an embodiment, the air duct upper cover 6042 is provided with a fan mounting portion 60422, a shape of the fan mounting portion 60422 matches a shape of the fan 602, and the fan 602 is fixedly connected to the fan mounting portion 60422. Optionally, the fan mounting portion 60422 forms part of a housing of the fan 602. Optionally, a second mounting portion 60423 is arranged on the fan 602, and the fan 602 is fixedly connected to the upper cover 101 through the second mounting portion 60423. Specifically, the second mounting portion 60423 is provided with a screw hole, and the fan 602 is fixedly connected to the upper cover 101 through a screw inserted into the screw hole.

Referring to FIG. 19 and FIG. 20, in an embodiment, the fan 602 includes an inlet 6022 and an outlet 6021. The outlet 6021 of the fan 602 is in fluid communication with one end of the air guide member 604, to be in fluid communication with the air duct 6011. Optionally, the inlets 6022 of the fans 602 may be arranged to have a same orientation. For example, in the embodiment shown in FIG. 20, the inlets 6022 of two fans 602 both face the upper cover 101. Optionally, the inlets 6022 of the fans 602 may be arranged to have different orientations. For example, in other embodiments, the inlet 6022 of one fan 602 faces the upper cover 101, and the inlet 6022 of the other fan 602 faces the interior of the seat 10. In the embodiment where the inlets 6022 of the fans 602 may be arranged to have different orientations, the fans 602 may be fans of a same model (the inlets 6022 of the fans 602 have a same orientation) to reduce a number of accessories and reduce manufacturing costs. In this embodiment, the two fans 602 are both configured to blow air towards the air duct 6011. In some embodiments, the two fans 602 are both configured to draw air from the air duct 6011. In some other embodiments, one fan 602 is configured to blow air towards the air duct 6011, and the other fan 602 is configured to draw air from the air duct 6011.

Referring to FIG. 23 to FIG. 25, in an embodiment, the child safety seat further includes a control apparatus 40. The control apparatus 40 includes: a control unit 401 and an operating unit 402. The control unit 401 is fixed to the fixed plate 605, and the fan 602 is electrically connected to the control unit 401. The operating unit 402 is arranged on the seat 10 and is communicably connected to the control unit 401. The operating unit 402 is configured to adjust an operating state of the fan 602. Optionally, referring to FIG. 16, the operating unit 402 is a controller arranged on the base 70. The control includes: a power switch 4021, a first indicator light 4024, a first seat angle adjustment button 4026, a second seat angle adjustment button 4027, a first fan on button 4028, and a first fan off button 4029. Optionally, the child safety seat further includes a wireless communication module, the control unit 401 is wirelessly and communicably connected to an external device through the wireless communication module, and the external device is configured to adjust the operating state of the fan 602. Optionally, the external device may be, for example, a remote control 90. For example, as shown in FIG. 25, the remote control 90 includes: a second indicator light 901, a third seat angle adjustment button 902, a second fan on button 903, a second fan off button 904, and a fourth seat angle adjustment button 905.

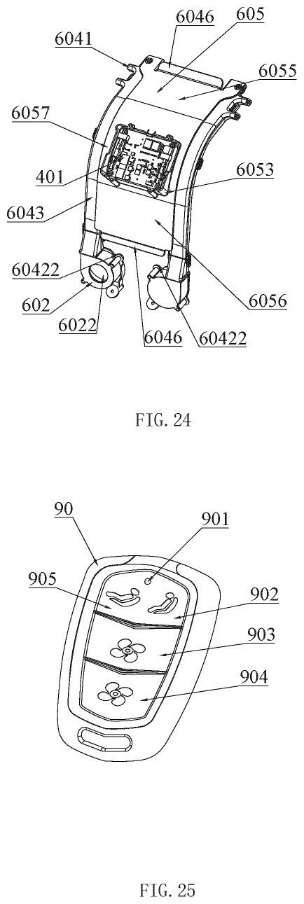

Optionally, referring to FIG. 24, a side of the connecting section 6057 of the fixed plate 605 facing away from the upper cover 101 is provided with a receiving box 6053 and a cover body 6054, the control unit 401 is fixedly arranged in the receiving box 6053, and the cover body 6054 is detachably fixed to the receiving box 6053 to close the receiving box 6053.

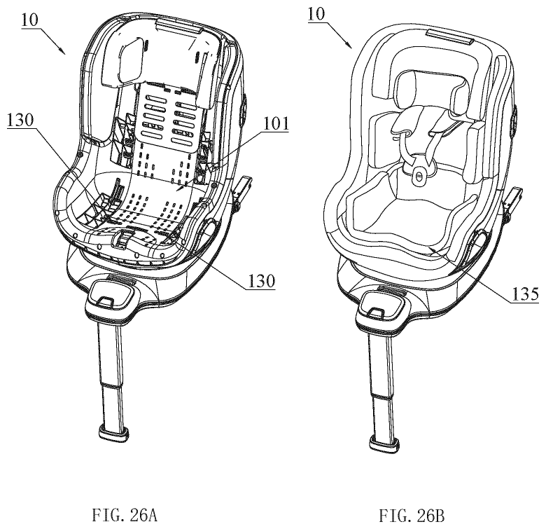

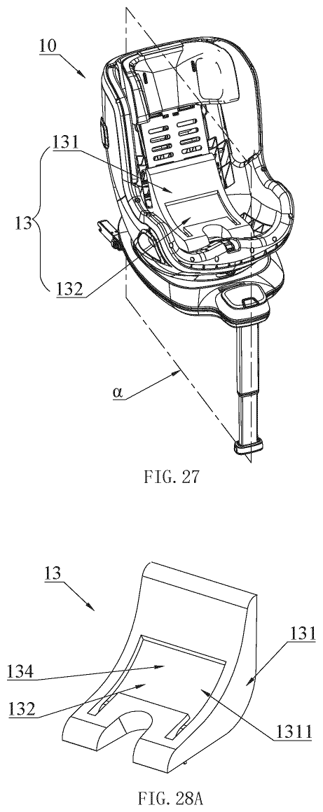

Referring to FIG. 26A to FIG. 27 together, according to an embodiment of the present disclosure, a child safety seat is further provided. The child safety seat includes a seat 10 and a support cushion assembly 13. As shown in FIG. 26A, the seat 10 includes an upper cover 101. The upper cover 101 is provided with a ventilation hole 130. The support cushion assembly is a safety seat accessory specially designed for smaller children and is configured to adjust a sitting space of the seat 10. In the case of a smaller child, the support cushion assembly may be mounted on the child safety seat to enable the child to maintain a correct sitting posture (see FIG. 26B). When the child grows larger, the support cushion assembly may be removed from the child safety seat and the child may sit directly on the child safety seat. The interior of the support cushion assembly is typically filled with thicker foam materials such as sponge and foam to protect heads, necks, and spines of young children. However, the support cushion assembly may block the vents on the upper cover of the seat, which reduces the heat dissipation effect, thereby affecting sitting comfort.

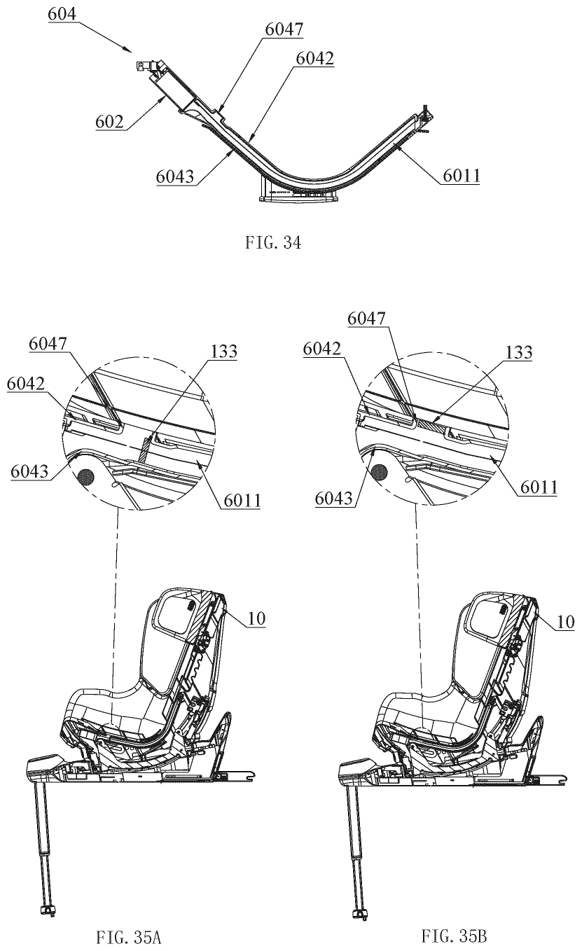

Referring to FIG. 26A and FIG. 32 to FIG. 34, according to an embodiment of the present disclosure, the child safety seat includes a seat 10 that further includes: an air guide member 604 arranged below the upper cover 101. The air guide member 604 has a hollow air duct 6011 and an air outlet port 6047. The air outlet port 6047 is arranged on a side of the air guide member 604 facing the upper cover 101 and is in fluid communication with the air duct 6011, and the air outlet port 6047 is inserted into the ventilation hole 130, thereby allowing gas in the air duct 6011 to flow to the upper surface of the upper cover 101. The support cushion assembly 13 is detachably mounted on the upper surface of the upper cover 101.

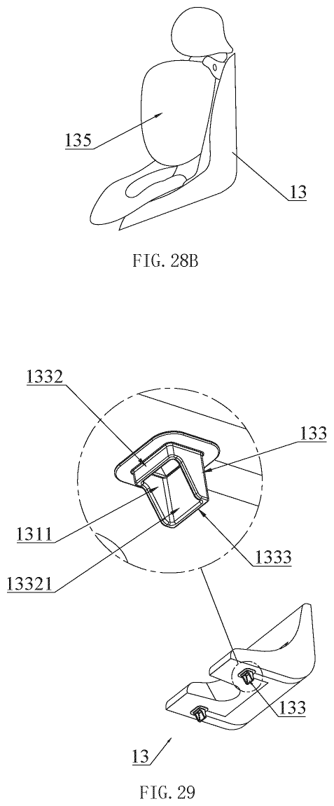

Referring to FIG. 28A to FIG. 29 together, in an embodiment according to the present disclosure, the support cushion assembly 13 includes a cavity 134 formed inside the support cushion assembly 13 and an air hole 1331 in fluid communication with the cavity 134. The air hole 1331 is in fluid communication with the air outlet port 6047. Therefore, gas exchange is allowed between the air duct 6011 of the air guide member 604 and the cavity 134 of the support cushion assembly 13. In actual use, through the gas exchange between the air duct 6011 and the cavity 134, heat in the support cushion assembly 13 is taken away to achieve an effect of lowering a temperature of the support cushion assembly 13. Specifically, in this embodiment, two ventilation holes 130 are provided, the two ventilation holes 130 are arranged on left and right sides of the upper cover 101 respectively, and one air guide member 604 is arranged below each ventilation hole 130, to provide a relatively uniform heat dissipation effect on the left and right sides of the upper cover 101. Those skilled in the art may understand that the numbers and the arrangement positions of the ventilation hole 130 and the air guide member 604 in this example are only exemplary, and those skilled in the art may select other suitable numbers and arrangement positions of the ventilation hole 130 and the air guide member 604 according to an actual requirement.

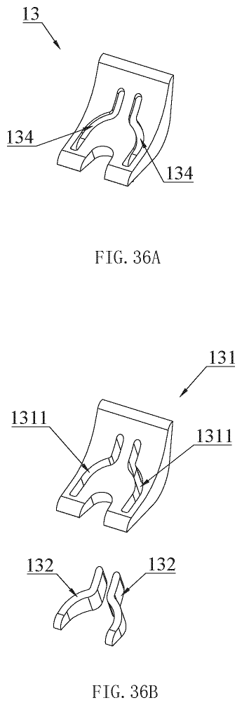

Still referring to FIG. 28A to FIG. 30, in an embodiment according to the present disclosure, a lower portion of the support cushion assembly 13 is protrudingly provided with a connecting member 133, the air hole 1331 is formed in the connecting member 133, and when the support cushion assembly 13 is mounted on the seat 10, the connecting member 133 is at least partially inserted into the air outlet port 6047 to enter the air duct 6011, so that the fan is in fluid communication with the cavity 134 inside the support cushion assembly 13. The support cushion assembly 13 includes a cushion body 131 and a cushion core 132. The cushion body 131 is provided with a through groove 1311 along a vertical direction. The cushion core 132 is inserted into the through groove 1311. A thickness of the cushion core 132 is less than a thickness of the cushion body 131. When the cushion core 132 is inserted into the through groove 1311, an upper surface of the cushion core 132 is slightly lower than an upper surface of the cushion body 131, thereby forming a cavity structure on a side of the support cushion assembly 13 close to the upper cover 101 to enhance heat exchange efficiency of the support cushion assembly 13. As shown in FIG. 28B, the support cushion assembly 13 further includes an outer shell, and the outer shell wraps the cushion body 131 and the cushion core 132. Therefore, the outer shell and a portion of the through groove 1311 not occupied by the cushion core 132 form the cavity 134. It is to be noted that in order to express internal features of the support cushion assembly 13, the outer shell is omitted in FIG. 28A and FIG. 36A. When the support cushion assembly 13 is mounted on the upper cover 101, part of the connecting member 133 is inserted into the air outlet port 6047 to enter the air duct 6011, in this case, the air duct 6011 is in fluid communication with the cavity 134 through the air holes 1331 in the connecting member 133, thereby realizing gas exchange between the air duct 6011 and the cavity 134. Specifically, in this embodiment, two connecting members 133 are provided, and the two connecting members 133 are both arranged on a bottom side of the support cushion assembly 13 and extend perpendicularly to a bottom surface of the support cushion assembly 13 in a direction away from the support cushion assembly 13. Those skilled in the art may understand that the number and the arrangement position of the connecting member 133 in this example correspond to the numbers and the arrangement positions of the ventilation hole 130 and the air guide member 604. In other embodiments, those skilled in the art may select other suitable numbers and arrangement positions of the connecting member 133 according to the numbers and the arrangement positions of the ventilation hole 130 and the air guide member 604. Further, the connecting member 133 may alternatively be used as a guide member when the support cushion assembly 13 is mounted, so as to rapidly position a mounting position of the support cushion assembly 13 on the upper cover 101.

Referring to FIG. 28A and FIG. 28B, in an embodiment according to the present disclosure, a side of the cushion body 131 facing away from the upper cover 101 is an arc-shaped surface, and the arc-shaped surface is provided with a through groove 1311. The outer shell may be wrapped around an outer side of the cushion body 131. When the user sits on the seat 10, the body is in contact with the outer shell, resulting in higher comfort. The cushion core 132 is made of a breathable material to improve breathability, so as to further improve sitting comfort. In this embodiment, the through groove 1311 is approximately positioned at the user's buttocks or back, and the cushion core 132 is arranged in the through groove 1311 to provide support and reduce fatigue after long-term sitting. Optionally, a portion of the outer shell corresponding to the through groove may be made of a material or structure with better air permeability, such as mesh cloth, to further improve breathability of the region and provide better sitting experience. In this embodiment, the cushion body 131 and the cushion core 132 are arranged separately, and the user may replace the cushion core 132 with a different property (such as material or hardness) according to an actual requirement. In other embodiments, the cushion body 131 and the cushion core 132 may alternatively be integrally formed, to improve mounting convenience. Optionally, as shown in FIG. 26B, a seat cushion 135 may further be mounted on the upper surface of the support cushion assembly 13, for example, to improve sitting comfort or to be suitable for younger infants. As shown in FIG. 28B, in an embodiment according to the present disclosure, the seat cushion 135 may be detachably connected to the support cushion assembly 13, for example, via a connecting mechanism such as a button or Velcro. In other embodiments, the seat cushion 135 may be designed as a structure integrated with the support cushion assembly 13.

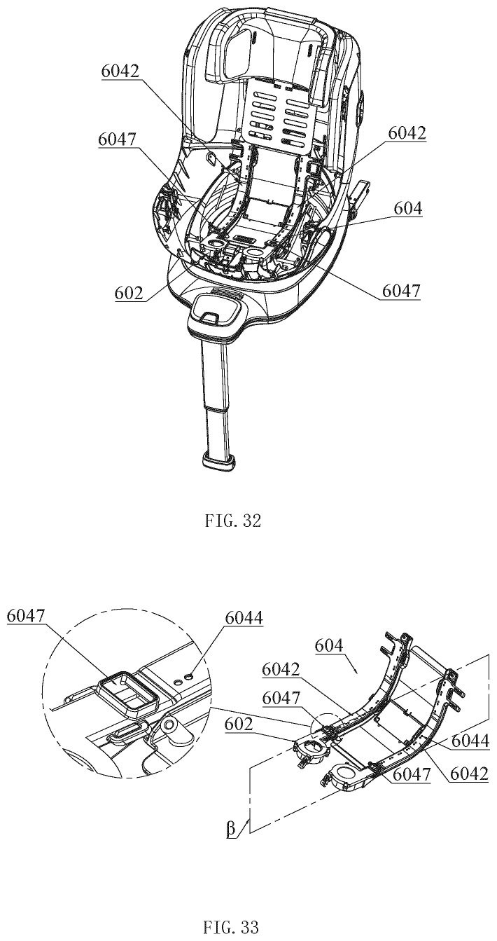

Referring to FIG. 32 to FIG. 34 together, in an embodiment according to the present disclosure, the air guide member 604 includes an air duct upper cover 6042 and an air duct lower cover 6043 inserted into and engaged with each other, and the air duct 6011 is formed between the air duct upper cover 6042 and the air duct lower cover 6043. Compared with the air guide member 604 in the foregoing embodiments, a side of the air guide member 604 in this embodiment facing the upper cover 101 is further provided with a protruding air outlet port 6047, and the air outlet port 6047 is inserted into the ventilation hole 130 of the upper cover 101.

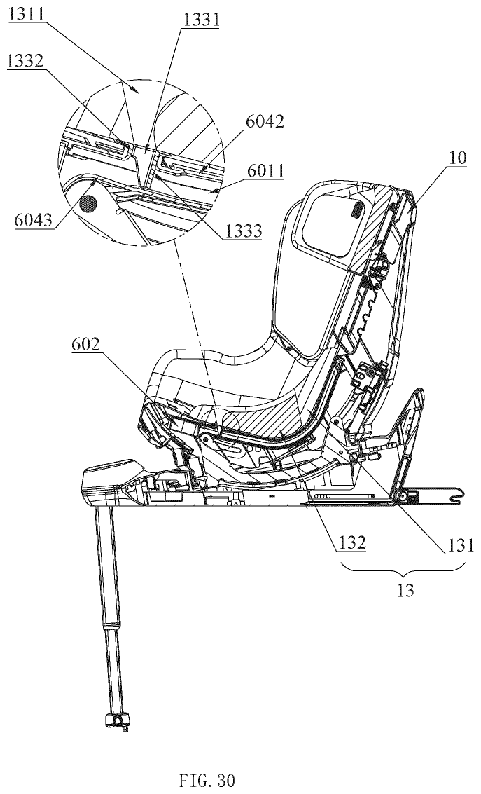

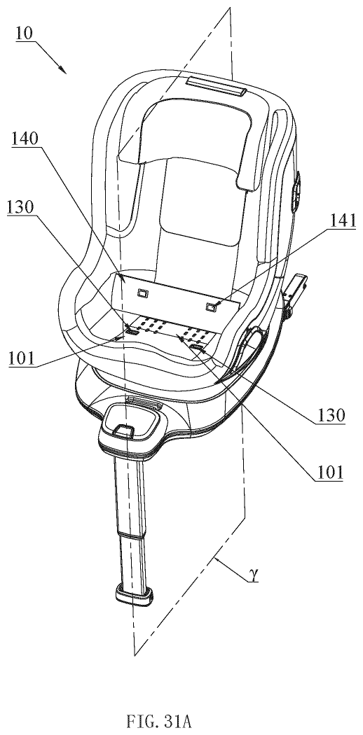

Referring to FIG. 30 and FIG. 33 together, in an embodiment according to the present disclosure, a fan 604 is arranged at one end of the air guide member 604, and the fan 604 is in fluid communication with the air duct 6011 of the air guide member 604. Rotation of the fan 602 generates power for gas flow in the air duct 6011. A plurality of second vents 6044 are arranged in an upper portion of the air guide member 604, and the ventilation holes 130 are located between the fan 604 and the second vents 6044. The connecting member 133 includes a windward portion 1332, for example, facing the fan 604 and a windshielding portion 1333, for example, facing away from the fan 604. The windward portion 1332 is arranged in fluid communication with the air hole (1331). Specifically, the windward portion 1332 is provided with an aperture 13321, and the aperture 13321 is in fluid communication with the air hole 1331. The windshielding portion 1333 is arranged to isolate fluid communication between the fan 604 and the ventilation hole 130. Specifically, the windshielding portion 1333 is configured to block the flow of air in the portion of the air duct 6011 away from the fan 604 and the windshielding portion 1333. Therefore, when the support cushion assembly 13 is mounted on the seat 10, the connecting member 133 blocks the air duct between the fan 604 and the second vent 6044. Only a very small part (or even almost none) of the airflow generated by the fan 604 flows out of the air duct 6011 through the second vent 6044, but most (or even substantially all) thereof enters the cavity of the support cushion assembly 13 through the aperture 13321 of the windward portion 1332, and finally completes gas exchange with the outside of the child safety seat through micropores on the material of the outer shell. In this way, the airflow generated by the fan 604 is maximized to take away heat in the support cushion assembly 13 to optimize the effect of lowering the temperature of the support cushion assembly 13. Optionally, an end of the portion of the connecting member 133 inserted into the ventilation hole 130 away from the support cushion assembly 13 is in contact with an inner wall on a side of the air guide member 604 opposite to the ventilation hole 130 to enhance a blocking effect of the windshielding portion 1333 on the airflow, which further optimizes the effect of lowering the temperature of the support cushion assembly 13 and improves sitting comfort of smaller children.

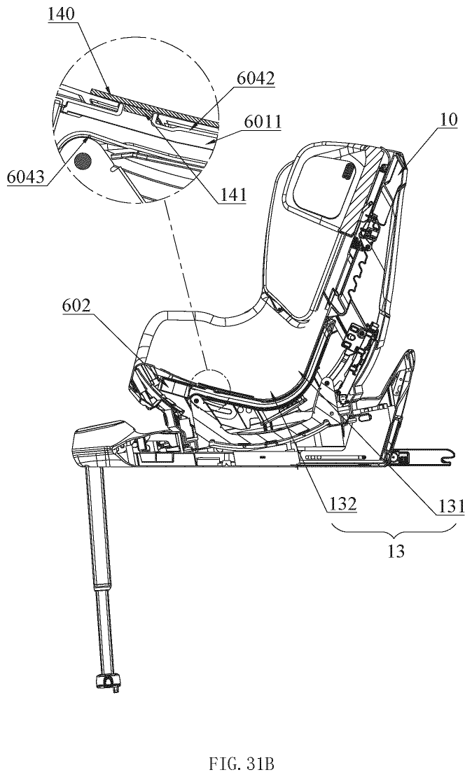

Referring to FIG. 31A and FIG. 31B, in an embodiment according to the present disclosure, the seat 10 further includes a shielding sheet 140 arranged on, for example, the upper surface of the upper cover 101 or seat cloth, and is configured to cover a partial region of the upper surface of the upper cover 101. For example, the shielding sheet 140 may cover the ventilation hole 130. Optionally, the shielding sheet 140 is provided with a hole-blocking member 141. When the shielding sheet 140 covers the ventilation hole 130, the hole-blocking member 141 closes the ventilation hole 130. Optionally, the hole-blocking member 141 has a plug-like structure to be embedded in and close the ventilation hole 130. When the support cushion assembly 13 is not mounted, the fan 604 is in communication with the second vent 6044 through the air duct 6011, and the ventilation hole 130 is closed through the shielding sheet 140 and the hole-blocking member 141, which can prevent the airflow from entering and exiting the ventilation hole 130, increase an air outlet volume at the second vent 6044, and improve sitting comfort of smaller children. In addition, an opening area of the ventilation hole 130 is larger than an opening area of the second vent 6044.

Optionally, in an embodiment according to the present disclosure, the shielding sheet 140 is a portion of the seat cloth covering the seat 10, and the shielding sheet 140 is pivotable relative to other portions of the seat cloth. Specifically, the shielding sheet 140 is, for example, substantially in a shape of a rectangle, and the shielding sheet 140 is pivotable with one of long edges thereof as an axis. In this way, the shielding sheet 140 is pivotable between an open position and a closed position. At the open position, the hole-blocking member 141 does not close the ventilation hole 130, so that the air hole 1331 can be in fluid communication with the air outlet port 6047. The shielding sheet 140 is part of the seat cloth. Therefore, the shielding sheet 140 is always on the upper cover 101, without fear of loss. Optionally, the shielding sheet 140 is made of a same material as other portions of the seat cloth, to reduce foreign body sensation to an occupant.

Referring to FIG. 35A and FIG. 35B, in an embodiment according to the present disclosure, the connecting member 133 is a cover plate, and the cover plate is pivotably arranged in the air duct 6011. Specifically, the cover plate is pivotably connected to the air duct upper cover 6042, and the pivoting cover plate may change an opening degree of the air outlet port 6047, thereby adjusting a ventilation flow rate. Specifically, when the cover plate rotates to completely block the air outlet port 6047, the cover plate reaches a first position. For example, referring to FIG. 35B, the cover plate is at the first position and completely blocks the air outlet port 6047. In this case, the airflow cannot pass through the air outlet port 6047, so that the gas exchange between the support cushion assembly 13 and the air duct 6011 is isolated, and the airflow generally flows in the air duct 6011. In actual use, generally, if there is no need to mount the support cushion assembly 13 or provide ventilation and heat dissipation for the support cushion assembly 13, the cover plate is pivoted to the first position. Still referring to FIG. 35A, the cover plate pivots to a second position and completely blocks the air duct 6011. In this case, the airflow is allowed to pass through the air outlet port 6047, so that the gas exchange between the support cushion assembly 13 and the air duct 6011 is allowed, and the airflow in the air duct 6011 is blocked by the cover plate. In actual use, generally, if there is a need to provide ventilation and heat dissipation for the support cushion assembly 13, the cover plate is pivoted to the second position.

In another embodiment according to the present disclosure, the cover plate may alternatively be arranged in the ventilation hole 130. For example, the cover plate is pivotably connected to a side wall of the ventilation hole 130, so that the cover plate is pivotable between the first position for blocking the ventilation hole 130 and the second position for blocking the air duct 6011. For example, when the cover plate pivots to the first position, the cover plate blocks the ventilation hole 130. In this case, the airflow cannot pass through the ventilation hole 130, so that the gas exchange between the support cushion assembly 13 and the air duct 6011 is isolated, and the airflow generally flows in the air duct 6011. In actual use, generally, if there is no need to mount the support cushion assembly 13 or provide ventilation and heat dissipation for the support cushion assembly 13, the cover plate is pivoted to the first position. When the cover plate pivots to the second position, the cover plate enters the air duct 6011 through the air outlet port 6047 and completely blocks the air duct 6011. In this case, the airflow is allowed to pass through the ventilation hole 130, so that the gas exchange between the support cushion assembly 13 and the air duct 6011 is allowed, and the airflow in the air duct 6011 is blocked by the cover plate. In actual use, generally, if there is a need to provide ventilation and heat dissipation for the support cushion assembly 13, the cover plate is pivoted to the second position.

Referring to FIG. 36A and FIG. 36B, in an embodiment according to the present disclosure, a support cushion assembly 13 is further provided. Compared with the support cushion assembly 13 in the embodiments shown in FIG. 26A to FIG. 35B, the support cushion assembly 13 in this embodiment is provided with two through grooves 1311 spaced apart from each other, the two through grooves 1311 are each provided with one cushion core 132 to form a cavity 34 respectively, and each cavity 134 is in fluid communication with at least one air hole 1331. In this embodiment, the two through grooves 1311 in the support cushion assembly 13 are spaced apart from each other and are not in communication with each other, thereby preventing the following situation: airflow generated by the fans 604 of the two air guide members 604 affect each other, such as generate vortexes, thereby weakening the flow of gas in the through groove 1311 and reducing the heat dissipation effect of the support cushion assembly 13.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1-6. (canceled)

7. A child safety seat, comprising:
a seat comprising an upper cover;
a plurality of fans and
a plurality of air guide members having a hollow air duct and a plurality of vents, the vents being arranged on a side facing the upper cover and in fluid communication with the air duct,
wherein the plurality of air guide members are in fluid communication with the plurality of fans respectively, the plurality of air guide members are spaced apart on two lateral sides of the upper cover respectively, and a recess is formed by the plurality of air guide members and the upper cover.

8. The child safety seat according to claim 7, wherein
the child safety seat further comprises a fixed plate being fixedly connected to at least two air guide members of the plurality of air guide members, and a channel is formed by the fixed plate and the recess.

9. The child safety seat according to claim 8, wherein
the air guide members are each provided with a carrying rib, the upper cover is provided with a first rib extending along a vertical direction, and a carrying hole is arranged in a side wall of the first rib, the carrying rib is inserted into the carrying hole to fix the air guide member to the upper cover.

10. The child safety seat according to claim 9, wherein
the upper cover is further provided with a second rib extending along a horizontal direction, and the first rib and the second rib form a reinforcing groove in the upper cover, the reinforcing groove is provided with a ventilation opening, and
an end of the carrying rib passing through the carrying hole is provided with an air opening in fluid communication with the air duct and in fluid communication with the upper cover through the ventilation opening.

11. The child safety seat according to claim 7, wherein
the air guide member further comprises an air outlet port in fluid communication with the air duct, the air outlet port is closer to the fan than the vent, and
the child safety seat further comprises:
a support cushion assembly being detachably mounted on the seat a cavity being formed inside the support cushion assembly, an air hole in fluid communication with the cavity being formed on a bottom surface of the support cushion assembly, and the air hole being configured such that the air hole is in fluid communication with the air outlet port when the support cushion assembly is mounted on the seat.

12. (canceled)

13. The child safety seat according to claim 12, wherein
the support cushion assembly is provided with a connecting member, and the air hole is formed in the connecting member, the connecting member being at least partially inserted into the air outlet port to enter the air duct,
wherein the connecting member comprises a windward portion in fluid communication with the air hole and a windshielding portion that separates fluid communication between the fan and the ventilation hole.

14. The child safety seat according to claim 12, further comprising:
a shielding sheet pivotably arranged on an upper surface of the upper cover or seat cloth, one side of the shielding sheet being provided with a hole-blocking member,
wherein the shielding sheet is pivotable between an open position and a closed position, at the closed position, the hole-blocking member closes the ventilation hole, and at the open position, the hole-blocking member does not close the ventilation hole to allow the air hole to be in fluid communication with the air outlet port.

15. The child safety seat according to claim 12, further comprising:
a connecting member pivotably connected to an air duct upper cover and pivotable between a first position for blocking the air outlet port and a second position for blocking the air duct.

16. The child safety seat according to claim 12, wherein
the support cushion assembly comprises:
a cushion body provided with a through groove; and
a cushion core arranged in the through groove;
wherein a thickness of the cushion core is less than a depth of the through groove, so that when the cushion core is arranged in the through groove, the cavity is formed in the through groove.

17. The child safety seat according to claim 7, wherein
the upper cover is provided with a through hole configured to allow a safety belt length adjustment end to pass through, the through hole being in communication with the recess.

18. The child safety seat according to claim 11 wherein
the child safety seat further comprises: a connecting member arranged on either of the seat and the support cushion assembly and capable of being inserted into the air outlet port to block a fluid communication between the fan and the vent.
